(19) United States
(12) Patent Application Publication
(10) Pub. No.: US 2026/0169550 A1
(43) Pub. Date: Jun. 18, 2026

(54) SYSTEM AND METHOD FOR OPTIMIZED AUGMENTED REALITY DISPLAY

(71) Applicant: Flying Flamingos India Private Limited, Bangalore (IN)

(72) Inventors: Amit Gaiki, Bangalore (IN); Shourya Agarwal, Ajmer (IN); Malhar Patil, Nagpur (IN); Divyansh Gupta, Banswara (IN)

(73) Assignee: Flying Flamingos India Private Limited, Bangalore, KA (IN)

(21) Appl. No.: 19/388,437

(22) Filed: Nov. 13, 2025

(30) Foreign Application Priority Data
Nov. 13, 2024 (IN) 202441087824

(51) Int. Cl. G06F 3/01; G06T 19/00

(52) U.S. Cl. CPC G06F 3/011; G06T 19/006; G06F 3/017; G06T 2200/24

(57) ABSTRACT

The present disclosure provides a method, computing system and a non-transitory computer readable storage medium for enabling interaction with mixed reality content. The method includes detecting a triggering action for accessing the mixed reality content at the communication device, and transforming the mixed reality content by superimposing one or more transparent video overlays having one or more virtual elements. Moreover, the method includes rendering the transformed mixed reality content on the communication device, receiving a user input for interacting with the one or more virtual elements and analyzing the user input to determine an interaction intent. Further, the method includes dynamically optimizing the mixed reality content based on the interaction intent. Furthermore, the method includes rendering the optimized mixed reality content on the communication device. The computing system achieves improved real-time responsiveness, reduced rendering latency, and enhanced spatial alignment accuracy during the user interaction with the mixed reality content.

### CROSS-REFERENCE TO RELATED APPLICATIONS

The present application claims the benefit of Indian Provisional Patent Application No. 202441087824, filed Nov. 13, 2024, all of which are hereby incorporated by reference in their entirety for all purposes.

### TECHNICAL FIELD

The present disclosure relates generally to mixed reality (MR) systems and methods. Specifically, the present disclosure relates to interaction and rendering techniques for mixed reality content on computing devices.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

Mixed Reality (MR) technologies have evolved to enable seamless integration of digital content with real-world environments. Mixed Reality technologies combine aspects of Augmented Reality (AR) and Virtual Reality (VR) to deliver immersive experiences. Current MR applications are typically platform-specific, and require separate installations for different operating systems. This restricts interoperability and limits accessibility for users and developers. Recently, instant applications have emerged as a lightweight alternative to enable quick access to MR experiences without full installation. However, these applications often face limitations such as restricted hardware access, reduced computational resources, and inconsistent rendering across devices with varying sensor and processing capabilities. As a result, maintaining real-time responsiveness, spatial accuracy, and high-quality mixed reality experiences remains a challenge, particularly for devices with limited performance resources.

### SUMMARY

In a first aspect, the present disclosure provides a computing system for enabling interaction with mixed reality content. The computing system includes one or more processors and a memory. The memory stores instructions that cause the one or more processors to detect a triggering action of a plurality of triggering actions for accessing the mixed reality content at the communication device. In addition, the one or more processors are caused to transform the mixed reality content to obtain a user interaction enabled mixed reality content. The user interaction enabled mixed reality content is obtained by superimposing one or more transparent video overlays. The one or more transparent video overlays include one or more virtual elements. The one or more virtual elements are overlaid onto a real-time view of an environment captured by a camera module of the communication device. Moreover, the one or more processors are caused to render the transformed mixed reality content on the communication device. Further, the one or more processors are caused to receive a user input for interacting with the user interaction enabled mixed reality content. The interaction is enabled through the one or more virtual elements. Next, the one or more processors are caused to analyse the received user input to determine an interaction intent associated with the mixed reality content. Further, the one or more processors are caused to dynamically optimize the mixed reality content based on the determined interaction intent by executing one or more actions on the mixed reality content. Furthermore, the one or more processors are caused to render the optimized mixed reality content on the communication device. The mixed reality content is updated and rendered continuously based on incremental user inputs to enable seamless interaction of the user with the mixed reality content.

In an embodiment of the present disclosure, the user input is received through the communication device. The user input includes one of a gesture based input, a voice based input, a touch based input or a text based input

In an embodiment of the present disclosure, the plurality of triggering actions corresponds to a mode for initiating a device-agnostic access to the mixed reality content. The plurality of triggering actions includes at least scanning of a Quick Response (QR) code through a camera module of the communication device, clicking on a hyperlink received on the communication device, and detection of a near-field communication (NFC) tag through the communication device.

In an embodiment of the present disclosure, the one or more transparent video overlays includes an alpha channel video overlay to preserve background transparency of the real-time view of the physical environment captured by the camera module of the communication device.

In an embodiment of the present disclosure, the alpha channel video overlay enables selective visibility of the one or more virtual elements and preserves a visibility of real-time imagery of the physical environment captured by the camera module.

In an embodiment of the present disclosure, the one or more virtual elements are integrated onto the real-time view captured by the camera module of the communication device.

In an embodiment of the present disclosure, the method includes adjusting the one or more transparent video overlays in real time based on at least a real time data from the camera module data and real time user movement data. The adjustment is done by enabling spatial alignment of the one or more virtual elements with the physical environment.

In an embodiment of the present disclosure, the mixed reality content is rendered using an adaptive user interface framework that dynamically adjusts a layout and interaction model. The adjustment is done based at least on user interaction history, device type, and environmental conditions.

In an embodiment of the present disclosure, the method includes dynamically optimizing an interaction experience for the user with the one or more virtual elements. The optimization of the interaction experience is done by executing a series of steps. The series of steps includes a first step of analysing at least one of user interaction data, user movement data and environmental data during interaction with the one or more virtual elements rendered within the mixed reality content. The series of steps includes a second step of prioritizing at least one of a type of user interaction and a layout type of the one or more virtual elements based on the analysis. The series of steps includes a third step of rendering the mixed reality content with optimized user interface based on the prioritizing.

In an embodiment of the present disclosure, the method includes anchoring the one or more virtual elements persistently within the physical environment. The anchoring includes a series of steps. The series of steps includes a first step of identifying one or more physical surfaces in the physical environment and contextually placing one or more digital objects relative to the one or more physical surfaces. The series of steps includes a second step of generating a visual preview of the one or more virtual elements overlaid in the physical environment. The series of steps includes a third step of dynamically adjusting spatial position of the one or more virtual elements based on the user input. The series of steps includes a third step of tracking user movement using data from a camera sensor. The series of steps includes a fifth step of dynamically updating at least one of a positioning, orientation, and appearance of the digital object in response to the user movement.

In an embodiment of the present disclosure, enabling the seamless interaction with the rendered mixed reality content includes simulating realistic physical responses on a rendered digital object rendered. The seamless interaction is enables based on the user input and changes in the physical environment.

In an embodiment of the present disclosure, the method includes activating a modular mixed reality engine based on detection of the triggering action of the plurality of triggering actions at the communication device. The modular mixed reality engine includes a plurality of mixed reality modules. Next, the method includes recognizing a usage context based on the user input, hardware capabilities of the communication device and environment data in real time. Next, the method includes identifying at least one mixed reality (MR) module from the plurality of mixed reality modules based on the usage context recognition in real time. The at least one mixed reality (MR) module includes at least one of an interactions module and assets module. Next, the method includes dynamically loading the at least one identified mixed reality module within a secure execution framework. Next the method includes rendering the mixed reality content with the interaction enabled one or more virtual elements on the communication device using the at least one identified mixed reality module. The rendering is done by deploying the secure execution framework on the communication device

In a second aspect, the present disclosure provides a computer-implemented method for enabling interaction with a mixed reality content. The method includes detecting a triggering action of a plurality of triggering actions for accessing the mixed reality content at the communication device. In addition, the method includes transforming the mixed reality content to obtain a user interaction enabled mixed reality content. The user interaction enabled mixed reality content is obtained by superimposing one or more transparent video overlays. The one or more transparent video overlays include one or more virtual elements. The one or more virtual elements are overlaid onto a real-time view of an environment captured by a camera module of the communication device. Moreover, the method includes rendering the transformed mixed reality content on the communication device. Further, the method includes receiving a user input for interacting with the user interaction enabled mixed reality content. The interaction is enabled through the one or more virtual elements. Next, the method includes analyzing the received user input to determine an interaction intent associated with the mixed reality content. Further, the method includes dynamically optimizing the mixed reality content based on the determined interaction intent by executing one or more actions on the mixed reality content. Furthermore, the method includes rendering the optimized mixed reality content on the communication device. The mixed reality content is updated and rendered continuously based on incremental user inputs to enable seamless interaction of the user with the mixed reality content.

In a third aspect, a non-transitory computer-readable medium is provided. The non-transitory computer-readable medium stores computer-executable instructions. The instructions are executed by one or more processors of a computing device. The execution of the instructions by the one or more processors causes the computing device to perform a method for enabling interaction with a mixed reality content. The method includes detecting a triggering action of a plurality of triggering actions for accessing the mixed reality content at the communication device. In addition, the method includes transforming the mixed reality content to obtain a user interaction enabled mixed reality content. The user interaction enabled mixed reality content is obtained by superimposing one or more transparent video overlays. The one or more transparent video overlays include one or more virtual elements. The one or more virtual elements are overlaid onto a real-time view of an environment captured by a camera module of the communication device. Moreover, the method includes rendering the transformed mixed reality content on the communication device. Further, the method includes receiving a user input for interacting with the user interaction enabled mixed reality content. The interaction is enabled through the one or more virtual elements. Next, the method includes analyzing the received user input to determine an interaction intent associated with the mixed reality content. Further, the method includes dynamically optimizing the mixed reality content based on the determined interaction intent by executing one or more actions on the mixed reality content. Furthermore, the method includes rendering the optimized mixed reality content on the communication device. The mixed reality content is updated and rendered continuously based on incremental user inputs to enable seamless interaction of the user with the mixed reality content.

### BRIEF DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 illustrates an interactive computing environment for enabling interaction with a mixed reality content, in accordance with various embodiments of the present disclosure;

FIG. 2 illustrates an exemplary block diagram of a computing system for enabling interaction with a mixed reality content, in accordance with various embodiments of the present disclosure;

FIG. 3A illustrates an exemplary environment for enabling trigger-based instantiation and modular deployment of mixed reality content, in accordance with various embodiments of the present disclosure;

FIG. 3B illustrates an exemplary environment depicting a computing system for downloading of interaction modules and associated visual assets, in accordance with an embodiment of the present disclosure;

FIG. 4 illustrates a flow chart of a method for enabling interaction with the mixed reality content, in accordance with various embodiments of the present disclosure; and

FIG. 5 illustrates a block diagram of an exemplary computing device configured for enabling interaction with the mixed reality content, in accordance with various embodiments of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote features throughout the specification and figures.

### DETAILED DESCRIPTION

In the following description of the disclosure and embodiments, reference is made to the accompanying drawings in which it is shown by way of illustration of specific embodiments that can be practiced. It is to be understood that other embodiments and examples can be practiced, and changes can be made without departing from the scope of the disclosure.

Although the following description uses the terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input can both be outputs and, in some cases, can be separate and different inputs.

The terminology used in the description of the various described examples herein is for the purpose of describing specific examples only and is not intended to be limiting. As used in the description of the various described examples and the appended claims, the singular forms “a,” “an,” and “the” are intended to include the plural forms as well, unless the context clearly indicates otherwise. It will be understood that the term “and/or” as used herein refers to and encompasses any and all possible combinations of one or more of the associated listed items. It will be understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

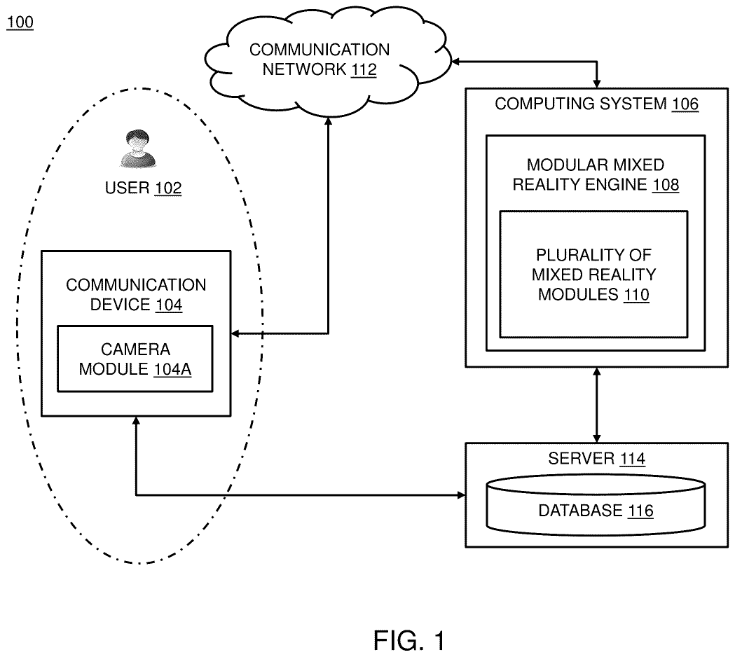

FIG. 1 illustrates an interactive computing environment 100 for enabling interaction with a mixed reality content, in accordance with various embodiments of the present disclosure. The interactive computing environment 100 enables rendering of the mixed reality content at a communication device 104.

The interactive computing environment 100 includes the communication device 104 associated with a user 102, a computing system 106, a communication network 112, a server 114 and a database 116. The communication device 104 interacts with the computing system 106 via the communication network 112. The components of the interactive computing environment 100 enable the interaction with the mixed reality content. In addition, the components of the interactive computing environment 100 render an interaction enabled mixed reality experience on the communication device 104. The components of the interactive computing environment 100 are operatively coupled and cooperatively function to enable dynamic deployment and optimized rendering of the mixed reality content tailored to contextual and device-specific conditions. The contextual conditions refer to real-time user input along with conditions associated with a physical environment surrounding the communication device 104. In addition, the components of the interactive computing environment 100 are operatively coupled and cooperatively function to enable optimization of the mixed reality content in real-time.

The interactive computing environment 100 delivers immersive experiences through dynamic, trigger-based activation. The interactive computing environment 100 enables orchestration of real-time loading of mixed reality modules within a kernel-level application sandbox on a Linux-based platform, ensuring optimal performance and security. The computing system 106 superimposes transparent videos onto the real-time view by utilizing alpha channel video overlays.

The mixed reality experience refers to a digitally enhanced immersive environment that blends virtual objects or augmentations with the physical world or environment in real-time. The mixed reality experience allows the user 102 to perceive and interact with digital and physical components in a spatially and temporally coherent manner. The mixed reality content encompasses at least digital assets, virtual objects, holograms, spatial audio, interactive controls, and context-sensitive information rendered within the mixed reality experience. The mixed reality content is rendered in real-time based on user input, environmental conditions, sensor data, and device capabilities. In addition, the mixed reality content includes dynamic overlays, gesture-responsive elements, or real-world object annotations.

In an embodiment of the present disclosure, the communication device 104 refers to any suitable user equipment configured to receive, render, and interact with the mixed reality content. Examples of the communication device 104 include a smartphone, tablet, smart glasses, wearable computing device, augmented reality (AR) headsets, and the like. Additionally, the communication device 104 may host a runtime environment capable of executing instant or transient mixed reality modules without requiring full application installation. The communication device 104 includes a camera module 104a. In an embodiment of the present disclosure, the camera module 104a includes a camera sensor, a depth sensor, and the like.

The user 102 may represent an individual interacting with the mixed reality content through the communication device 104. The user 102 may initiate mixed reality experiences by scanning a Quick response (QR) code, clicking an app link, or triggering the modular mixed reality engine 108 via other scannable or link-based mechanisms.

The computing system 106 may include one or more processors, memory units, and a rendering engine configured to generate and deliver the mixed reality content to the communication device 104. The rendering engine may leverage spatial mapping data, object recognition modules, or user-specific behavioral profiles to adapt the mixed reality content in real-time. Additionally, the communication network 112 may include wired or wireless channels, such as 5G, Wi-Fi, or satellite links, to facilitate low-latency content synchronization and interaction. The server 114 may manage user sessions, content orchestration, and system-wide updates, while the database 116 may store user profiles, contextual data, device parameters, and pre-rendered or modular content components.

In an embodiment of the present disclosure, the computing system 106 includes a modular mixed reality engine 108. The modular mixed reality engine 108 includes a plurality of mixed reality modules 110. The modular mixed reality engine 108 orchestrates loading of at least one module of the plurality of mixed reality modules 110 in real-time. The dynamic loading of the at least one module is done based at least on the real-time user inputs and environmental data. The dynamic loading features ensures an optimized performance and user experience. In an implementation, the modular mixed reality engine 108 may be a modular and platform-agnostic MR engine. The computing system 106 allows seamless deployment of the mixed reality content by leveraging real-time context awareness, dynamic module loading, and lightweight instant applications.

In an embodiment of the present disclosure, the modular mixed reality engine 108 serves as the core of the computing system 106. The modular mixed reality engine 108 is responsible for rendering MR content and managing various modules that comprise the MR experience. The plurality of mixed reality modules 110 run within a kernel-level application sandbox in a Linux-based system.

The computing system 106 enables interaction of the user 102 with virtual overlays via multimodal inputs for triggering events such as content playback adjustments or interactive feature activation. The computing system 106 enables adaptive streaming in the mixed reality content. Also, the computing system 106 uses masked videos for rendering transparent videos. Further, the computing system 106 utilizes dynamic model processes to download and use custom tracking libraries for devices that lack native support for image tracking. The computing system 106 enables real-time module management. The computing system 106 continuously monitors user interactions and environmental inputs (e.g., sensor data) to determine which MR modules are necessary at any given moment. The computing system 106 is configured to load only required modules in order to optimize resource utilization and enhance the user experience. Additionally, the computing system 106 runs the plurality of mixed reality modules 110 in the kernel-level sandbox to provide isolation from the rest of the computing system. The computing system 106 ensures that any malfunction or security issue within a module does not affect the overall stability or security of the communication device 104.

The computing system 106 enables cross-module communication between the plurality of mixed reality modules 110. The cross-module communication facilitates real-time data exchange between different MR modules. The cross-module communication ensures seamless interaction between 2D alpha content and 3D environment mapping, thereby enhancing the realism of the MR experience. In an embodiment of the present disclosure, the seamless integration enables the plurality of mixed reality modules 110 to communicate so that virtual elements (e.g., 2D overlays) are accurately positioned and synchronized with the 3D environment. The event-driven architecture allows the plurality of mixed reality modules 110 to publish and subscribe to events for enabling coordinated operation. The computing system 106 ensures that security and isolation are maintained as communication occurs within the sandbox. Thus, the computing system 106 prevents external interference and ensures system integrity. For example, in an MR game, when a user interacts with a 2D alpha channel overlay (e.g., a virtual button), the input is communicated to the 3D rendering module, which then updates the game environment accordingly, or vice versa.

In another embodiment of the present disclosure, the modular mixed reality engine 108 may orchestrate unloading of at least one module of the plurality of mixed reality modules 110 in real-time. The dynamic unloading of the at least one module is done based at least on the real-time user input and the physical environmental data. The dynamic unloading feature ensures an optimized performance and user experience. In an implementation, the modular mixed reality engine 108 may be a modular and platform-agnostic MR engine. The computing system 106 allows seamless deployment of the mixed reality content by leveraging real-time context awareness, dynamic module loading, and lightweight instant applications.

The plurality of mixed reality modules 110 operate within a kernel-level application sandbox or a secure sandbox environment in a Linux-based system to provide security and efficiency. In an embodiment of the present disclosure, the secure sandbox environment is established through context-aware permission management and a secure execution framework. The secure sandbox environment ensures at least security and stability during the rendering of the mixed reality content.

In an embodiment of the present disclosure, the computing system 106 enables adaptive data streaming for adjusting data streaming rates based on network conditions and device performance while integrating edge computing for efficiency. In an embodiment of the present disclosure, the computing system 106 enables cross-module communication for facilitating real-time data exchange between at least two modules of the plurality of mixed reality modules 110. In addition, the cross-module communication enhances realism of the mixed reality experience through seamless interaction between 2D alpha content and 3D environment mapping. Moreover, the cross-module communication enables the seamless interaction between the mixed reality modules configured for enabling the interaction of the user 102 with the mixed reality content.

In an embodiment of the present disclosure, the computing system 106 provides an adaptive user interface framework that dynamically adjusts based on user interactions and environmental factors. The adaptive user interface framework provides an intuitive and immersive experience. In an embodiment of the present disclosure, the adaptive user interface framework enables a responsive design for different devices, contextual controls appearing when relevant, and support for touch, gestures, and voice input. For example, in a navigation app, UI elements adjust based on whether the user is walking or driving. Additionally, the computing system 106 employs haptic feedback integration. The haptic feedback integration enhances immersion by providing tactile responses, such as vibrations or force feedback. In an example, in an MR shopping app, when a user selects a virtual product, a vibration simulates the sensation of picking up an item.

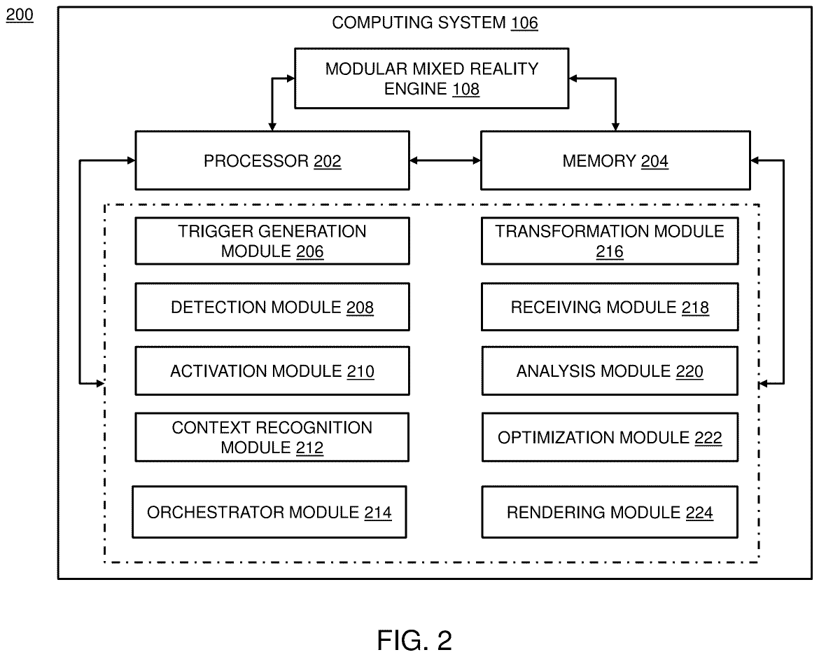

The communication device 104 works in conjunction with the computing system 106, the server 114 and the modular mixed reality engine 108 to perform a set of functions. The set of functions include at least reception of user input for real-time interaction, recognition of intent of interaction based on the user input, dynamically optimizing the mixed reality content based on the interaction intent by dynamically loading appropriate mixed reality modules, and rendering optimized and interactive content responsive to the real-time user input and the physical environmental conditions (explained below in the detailed description of FIG. 2).

The communication network 112 serves as the backbone of the interactive computing environment 100, enabling seamless communication between the communication device 104, the computing system 106, the server 114 and the database 116. Various entities in the interactive computing environment 100 may connect to the communication network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE) communication protocols, future communication protocols or any combination thereof.

The communication network 112 provides an infrastructure for seamless communication between the communication device 104, the computing system 106, the server 114 and the database 116. In some implementations, the communication network 112 includes internet, intranet, Wi-Fi, or other wired or wireless communication technologies.

The server 114 may refer to a backend processing system or a cloud-based infrastructure configured to coordinate, manage, and support the delivery of the interaction enabled mixed reality content to the communication device 104. In an embodiment of the present disclosure, the server 114 includes one or more computing devices configured to manage backend operations. The operations include but are not limited to, processing user requests, storing and updating MR content modules, and executing cloud-based rendering operations. In addition to above, the server 114 may manage user sessions and maintain communication with the communication device 104. The server 114 may incorporate application programming interfaces (APIs), load-balancing modules, analytics engines, and orchestration logic to dynamically coordinate mixed reality experiences across users and devices.

In an embodiment of the present disclosure, the server 114 is associated with one or more remote computing entities. The one or more remote computing entities are responsible for facilitating core services required for managing and supporting the delivery of the interaction enabled mixed reality (MR) experiences. The server 114 operates as an orchestrator that communicates with the computing system 106 and the communication device 104 over the communication network 112. In one example, the server 114 may host APIs, decision engines, and application services configured to process user interactions, manage MR session states, authenticate user access, and deliver relevant MR content modules to downstream components.

In certain implementations, the server 114 may enforce access controls, implement deployment policies, and manage caching of frequently accessed MR assets to enhance responsiveness and delivery speed. The server 114 plays a key role in mediating communication between the modular mixed reality engine 108 on the communication device 104 and the backend infrastructure. The server 114 enables seamless synchronization and dynamic loading of mixed reality modules across heterogeneous client platforms for rendering the interaction enabled mixed reality content.

In an embodiment of the present disclosure, the server 114 and the computing system 106 are architecturally distinct but interoperable components of the interactive computing environment 100. The server 114 and the computing system 106 perform complementary functions to facilitate MR content delivery and interaction. The server 114 acts as a backend orchestrator and processing layer, implemented using centralized or distributed cloud resources. The server 114 is configured to manage session states, execute intensive computational operations such as spatial computation and scene analysis, personalize MR content based on user input, and transmit context-aware MR assets to client-side rendering components.

The server 114 may refer to a backend processing system or cloud-based infrastructure that coordinates, manages, and supports the rendering of the mixed reality content delivered to the communication device 104. In an embodiment of the present disclosure, the server 114 and the computing system 106 represent architecturally distinct yet interoperable components of the interactive computing environment 100. Each of the server 114 and the computing system 106 are configured to perform complementary functions in support of the mixed reality content delivery and interaction. The server 114 functions as a backend processing and orchestration layer, implemented as a cloud-based infrastructure or centralized computing resource. The server 114 is configured to manage user sessions, perform computationally intensive operations such as spatial computation, scene understanding, and MR content personalization, and deliver contextually relevant MR assets to client-side components.

The server 114 may host, manage and remotely execute an instant application mechanism for enabling the dynamic delivery of one or more mixed reality modules. The one or more mixed reality modules are configured for enabling the interaction of the user 102 with the mixed reality content. In addition, the server 114 ensures delivery of platform and device independent user experiences. The server 114 may serve as an edge computing or localized processing layer that interfaces directly with the communication device 104. The server 114 is configured to handle real-time operations. The operations include at least adaptive user interface control, haptic feedback coordination, sensor data ingestion, and latency-sensitive mixed reality content rendering.

In an example implementation of a distributed computing environment and shown in FIG. 1, the computing system 106 is operatively connected to the server 114. The server 114 hosts a database 116. The server 114 handles client requests and provides necessary data to the computing system 106 for processing and rendering of mixed reality content. The computing system 106 and the server 114 are communicatively coupled via the communication network 112. The computing system 106 and the server 114 cooperatively function to enable scalable, immersive, and responsive mixed reality experiences across heterogeneous devices and usage contexts.

In another example implementation, the computing system 106 includes or is operatively connected to the database 116 for storing localized content or cached user session data (not shown in illustration). The computing system 106 is operatively connected to the server 114 hosting the database 116. The server 114 handles client requests and provides necessary data to the computing system 106 for processing and rendering of the interaction enabled mixed reality content.

The computing system 106 may include a combination of software components, processing units, micro services, or virtualized containers that handle multiple tasks. The tasks include module selection, compatibility evaluation, mixed reality asset delivery, spatial computation, and the like. The computing system 106 herein may represent a cloud server, an edge computing node, or a centralized processing system. In an embodiment of the present disclosure, the computing system 106 includes the database 116. In another embodiment, the database 116 is associated and remotely connected to the computing system 106. In one implementation, the computing system 106 may include one or more server-grade machines or distributed cloud-based computing resources configured to perform the rendering of the mixed reality content. The computing system 106 may include a plurality of software modules and processing components operative to execute the rendering of the mixed reality content. In an example implementation scenario, the rendering may include data pre-processing, feature extraction, segmentation model inference, and post-processing operations.

The database 116 refers to one or more data storage systems that store structured and unstructured information necessary for supporting and rendering the interactive mixed reality experience. In an embodiment of the present disclosure, the database 116 herein may correspond to a non-transitory storage system caused to persistently store real-time information for the rendering of the interactive mixed reality content. The database 116 may include at least mixed reality module repositories, user profiles, mixed reality experience identifiers (IDs), device compatibility matrices, content metadata, and environmental context logs. In addition, the database 116 may contain pre-trained machine learning models used for dynamic prediction of mixed reality modules. The database 116 enables real-time data retrieval and synchronization across the computing system 106 and the server 114 to ensure that relevant mixed reality assets are efficiently selected, delivered, and rendered at the communication device 104. The database 116 may be implemented as a distributed cloud database or a hybrid architecture to support scalability, redundancy, and low-latency data access.

The database 116 herein may correspond to a collection of information that is organized so that it can be easily accessed, managed and updated. In some implementations, the database 116 may include relational databases, NoSQL databases, cloud-based databases, graph databases, in-memory databases, and the like.

In an embodiment of the present disclosure, the server 114 exists as an external host for the computing system 106 (as shown in FIG. 1). The database 116 may be integrated within the server 114. In another embodiment, the server 114 may host the computing system 106 (not shown in FIG. 1). The database 116 may be integrated within the server 114 for retrieving at least mixed reality assets, spatial data, and user interaction logs.

It is shown in FIG. 1 that a single user (the user 102) accesses a single device (the communication device 104) for accessing and interacting with the mixed reality content; however, it will be appreciated by those skilled in the art that there may be any number of users simultaneously accessing corresponding devices in real-time for accessing and interacting with the mixed reality content.

The number and arrangement of systems, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the interactive computing environment 100 may perform one or more functions described as being performed by another set of systems or another set of devices of the interactive computing environment 100.

FIG. 2 illustrates an exemplary block diagram 200 of the computing system 106 for enabling interaction with the mixed reality content, in accordance with various embodiments of the present disclosure. Please note that in order to explain system elements of FIG. 2, references will be made to the computing system elements of FIG. 1 for clarity and ease.

The computing system 106 includes one or more processors, such as a processor 202. In addition, the computing system 106 includes a memory 204, and the modular mixed reality engine 108.

In an embodiment of the present disclosure, the modular mixed reality engine 108 corresponds to a hardware-integrated software orchestration framework. The software orchestration framework is configured to manage the transformation, the rendering, and the interaction of the mixed reality (MR) content in real time. The modular mixed reality engine 108 operates in conjunction with the processor 202, the memory 204, and the camera module 104a of the communication device 104 to dynamically execute the at least one mixed reality module 110 within a secure execution framework. Each of the plurality of mixed reality modules 110 perform a specific function such as interaction recognition, video overlay rendering, or spatial alignment of the one or more virtual elements with the physical environment.

The modular mixed reality engine 108 performs adaptive resource scheduling between graphical, sensor, and input-processing tasks based on device capabilities and contextual parameters. The hardware-software cooperation ensures that the processor 202 cycles are allocated dynamically for tasks such as real-time decoding of the transparent video overlays, gesture detection, and alpha channel blending. The memory bandwidth is balanced between transient frame buffers and persistent data structures. The coordination between the processor 202 and the memory 204 minimizes rendering interruptions, reduces processing latency, and ensures stable frame continuity during interaction-intensive operations.

In an embodiment of the present disclosure, the modular mixed reality engine 108 enables hardware-assisted optimization through parallel rendering pipelines that synchronize camera data streams, overlay composition, and user interface updates. The modular mixed reality engine 108 interacts with the graphics processing subsystem of the communication device 104 to perform low-level alpha blending and frame composition using hardware acceleration. The secure execution framework of the modular mixed reality engine 108 employs kernel-level sandboxing and context-aware permission control. Further, the secure execution framework ensures isolation between active modules and prevents system-level resource conflicts. The hardware-aware orchestration provides technical advantages, such as reduced rendering latency, improved responsiveness to the user interactions, and enhanced visual consistency across mixed reality sessions.

The computing system 106 architecture enables the hardware-level adaptation of the rendering and the sensor-processing parameters across the processor 202, the memory 204, and the camera module 104a of the communication device 104. The processor 202 manages concurrent tasks of frame composition, user-input tracking, and video overlay synchronization through adaptive thread scheduling. The memory subsystem dynamically reallocates the bandwidth for the real-time rendering operations. The camera module 104a provides continuous feedback on the environment and motion, utilized by the rendering subsystem to adjust the overlay transparency and the spatial orientation. The hardware-driven synchronization between the sensing and the rendering components minimizes the computational overhead. In addition, the hardware-driven synchronization ensures that the rendered one or more virtual elements remain consistently aligned with the user perspective and the device movement. As a result, the computing system 106 exhibits enhanced rendering performance, reduced frame lag, and improved perceptual stability during the real-time user interaction within the mixed reality environment.

Further, the computing system 106 includes a trigger generation module 206, a detection module 208 and an activation module 210. In addition, the computing system 106 includes a context recognition module 212, an orchestrator module 214, a transformation module 216 and a receiving module 218. Furthermore, the computing system 106 includes an analysis module 220, an optimization module 222 and a rendering module 224. It should be noted that the above mentioned system elements are exemplary system elements; however, there may be more system elements for the computing system 106.

The memory 204 stores instructions that, when executed, cause the processor 202 to be operable to perform rendering of the interaction enabled mixed reality content at the communication device 104. The processor 202 is in communication with the modular mixed reality engine 108, the trigger generation module 206, the detection module 208 and the activation module 210. In addition, the processor 202 is in communication with the context recognition module 212, the orchestrator module 214, the transformation module 216 and the receiving module 218. Further, the processor 202 is in communication with the analysis module 220, the optimization module 222 and the rendering module 224.

In an embodiment of the present disclosure, the computing system architecture enables hardware-level adaptation of rendering and sensor-processing parameters across the one or more processor, the non-transitory memory, and the camera module 104a of the communication device 104. The processors manage concurrent tasks of frame composition, user-input tracking, and video overlay synchronization through adaptive thread scheduling, while the memory subsystem dynamically reallocates bandwidth for real-time rendering operations. The camera module 104a provides continuous feedback on environmental lighting and motion, which is utilized by the rendering subsystem to adjust overlay transparency and spatial orientation. This hardware-driven synchronization between sensing and rendering components minimizes computational overhead and ensures that rendered virtual elements remain consistently aligned with user perspective and device movement. As a result, the computing system exhibits enhanced rendering performance, reduced frame lag, and improved perceptual stability during real-time user interaction within the mixed reality environment.

The elements of the computing system 106 collectively work in synchronization to enable the user 102 to access and interact with the mixed reality experience. The mixed reality experience is deployed in a distributed computing environment. The distributed computing environment includes the communication device 104, the computing system 106 with the modular mixed reality engine 108, and the server 114 operably coupled with the database 116. The computing system 106 is executed locally via a transient runtime on the communication device 104. The computing system 106 is configured to render the interactive MR content based on metadata and instructions received from the server 114 in response to one or more triggering actions, and the user input. The processor 202 executes one or more instructions stored in the memory 204 for enabling the user 102 to access and interact with the mixed reality content on the communication device 104.

The trigger generation module 206 is configured to generate a plurality of access triggers. The plurality of access triggers include an image trigger, a URL trigger, a scannable code based trigger such as a Quick Response (QR) code, a video trigger, and the like. The trigger generation module 206 generates universal links compatible with any device, regardless of operating system. The trigger generation module 206 generates Uniform Resource Locators (URLs) or Uniform Resource Identifiers (URIs) adhering to standard web protocols. The generated Uniform Resource Locators (URLs) or the Uniform Resource Identifiers (URIs) ensure compatibility across Android, iOS, Windows, and web browsers.

The processor 202 executes an instruction that causes the detection module 208 to detect a triggering action of the plurality of triggering actions for accessing the mixed reality content at the communication device 104. In an embodiment of the present disclosure, the plurality of triggering actions corresponds to the mode for initiating the device-agnostic and platform-agnostic access to the mixed reality content. The device-agnostic and platform-agnostic access refers to enabling access to the mixed reality content independently of a specific type, make, model, or operating system of the communication device. The computing system 106 enables access across a heterogeneous set of user devices, without requiring device-specific configurations or adaptations to enable a hardware or platform independent access to the mixed reality content.

In an embodiment, the plurality of triggering actions includes but may not be limited to scanning a Quick response (QR) code, clicking a hyperlink, detecting a near-field communication (NFC) tag, receiving a voice command, or recognizing a gesture input. In an embodiment of the present disclosure, the Quick response (QR) code may be captured through one or more cameras of the communication device 104, decoded, and utilized to extract metadata required for initializing the modular mixed reality engine 108. In an example, a user scans a Quick response (QR) code or follows a link for initiating a mixed reality experience through an instant app, bypassing the need for app installation.

In an embodiment of the present disclosure, clicking the hyperlink received on the communication device 104 facilitates initiation of loading metadata linked to the hyperlink for activating the modular mixed reality engine 108. The metadata includes at least one of a mixed reality (MR) experience identifier, asset locations, and one or more parameters controlling the mixed reality (MR) experience. In an embodiment of the present disclosure, detection of the NFC tag through the communication device 104 includes establishing a near-field communication session, retrieving data stored on the NFC tag and utilizing the retrieved data to activate the modular mixed reality engine 108.

In an embodiment of the present disclosure, each of the plurality of triggering actions includes a universal access link compatible with the hardware capabilities of the communication device 104 and the physical environmental data. The universal access link includes metadata embedded in at least one of the plurality of triggering actions. The link contains embedded metadata. The metadata includes at least one of a mixed reality (MR) experience identifier, asset locations, and one or more parameters controlling the mixed reality (MR) experience.

In an embodiment of the present disclosure, the trigger generation module 206 embeds these links into mediums like Quick response (QR) codes, NFC tags, or hyperlinks sent via messaging platforms. For example, a museum uses the module to create Quick response (QR) codes placed next to exhibits, allowing visitors to scan the codes and instantly access MR experiences related to each exhibit without installing any apps.

The scanning of the Quick response (QR) code includes capturing an image of the Quick response (QR) code using the camera module 104a of the communication device 104. Also, scanning of the Quick response (QR) code includes decoding of the captured image to extract encoded information and initiate activation of the modular mixed reality engine 108 using the extracted information. Further, clicking on the hyperlink received on the communication device 104 facilitates initiating a process of loading metadata linked to the hyperlink for activating the modular mixed reality engine 108. Also, detection of the NFC tag through the communication device 104 includes establishing a near-field communication session, retrieving data stored on the NFC tag, and utilizing the retrieved data to activate the modular mixed reality engine 108.

In an embodiment of the present disclosure, the system architecture enables interaction with the mixed reality content and facilitates the rendering by employing a dynamic module identification and loading approach. The dynamic module identification and loading approach is enabled through the activation module 210, the context recognition module 212 and the orchestrator module 214. This approach ensures that only contextually relevant modules are identified, and deployed for transformation and rendering of the user interaction enabled mixed reality content.

In an embodiment of the present disclosure, the activation module 210 activates the modular mixed reality engine 108 in response to the detected triggering action. The modular mixed reality engine 108 includes the plurality of mixed reality modules 110. The modular mixed reality engine 108 is activated based on the detection of the triggering action of the plurality of triggering actions at the communication device 104.

In an embodiment of the present disclosure, the context recognition module 212 is configured to recognizing the usage context-based on the hardware capabilities of the communication device 104, the environmental data and the embedded metadata associated with the detected triggering action in real-time. In an embodiment of the present disclosure, upon activation, the modular mixed reality engine 108 initiates a context-aware process that enables recognizing the usage context. Recognizing the usage context includes continuously assessing device resource availability based on a set of parameters. The set of parameters includes at least CPU utilization, GPU utilization, battery state, network state and thermal limits. Further, the embedded metadata is utilized for determining a particular mixed reality content requested for access through the mixed reality experience ID. In addition, the embedded metadata contains a request for rendering the mixed reality content with interaction ability.

In an embodiment of the present disclosure, the orchestrator module 214 is configured to identify the at least one mixed reality (MR) module from the plurality of mixed reality modules 110 based on the usage context recognition in real-time. In an embodiment, the at least one mixed reality (MR) module includes at least one of an interactions module and assets modules for enabling the transformation of the mixed reality content. In an embodiment, the orchestrator module 214 identifies the at least one mixed reality (MR) module based on one or more pre-defined criteria along with the usage context. In an embodiment of the present disclosure, the one or more pre-defined criteria include at least one of a type of the communication device 104, the hardware capabilities of the communication device 104, operating system specifications of the communication device 104, types of sensors in the communication device 104, and rendering capacity of the communication device 104.

In an embodiment of the present disclosure, the plurality of mixed reality modules 110 includes at least a flat image tracking module, a curved image tracking module, a ground tracking module, interactions module, and an object tracking module. Each of the plurality of mixed reality modules 110 is configured to render the mixed reality content on the communication device 104 in real-time. Each of the plurality of mixed reality modules 110 is associated with one or more pre-defined functionalities configured for dynamic loading, execution, and unloading based on contextual requirements.

In an embodiment of the present disclosure, the orchestrator module 214 is configured to dynamically load and deploy the at least one identified mixed reality module within the secure execution framework. The dynamic loading enables rendering of the mixed reality content with the interaction enabled one or more virtual elements on the communication device 104.

In an embodiment of the present disclosure, after activation, the modular mixed reality engine 108 communicates with the server 114, which acts as a backend orchestration entity. The server 114 is configured to receive and analyze the usage context data from the communication device 104 and determine suitable mixed reality modules from the plurality of mixed reality modules 110. The selected or identified modules may include, but are not limited to, an interactions module for processing user input in real-time, and one or more asset or tracking modules necessary for rendering virtual elements. The modular mixed reality engine 108 dynamically loads and executes the identified MR modules within the secure execution framework.

In an embodiment of the present disclosure, the secure execution framework corresponds to a kernel-level sandboxed environment instantiated through an instant application mechanism. The instant application mechanism involves the temporary deployment of an instant application on the communication device 104 without requiring full installation. In an embodiment, the instant application is lightweight, with a pre-defined size ranging from approximately 900 kilobytes to 1.2 megabytes. The orchestrator module 214 is configured to dynamically load the appropriate mixed reality (MR) modules in real-time based on the context derived from the device capabilities, the environmental data and the embedded metadata. The loaded modules operate within the kernel-level sandbox on a Linux-based system, thereby ensuring optimized execution performance, modular isolation, and secure handling of user interactions and rendered content. In an embodiment of the present disclosure, the modular mixed reality engine 108 enables cross-module communication. In an example, the cross-module communication facilitates real-time data exchange between the plurality of MR modules 110, ensuring seamless interaction between 2D alpha content and 3D environment mapping.

In an example, the interactions module may be used to enable real-time interaction with the one or more transparent video overlays superimposed on the real-time view. The one or more transparent video overlays may include alpha channel video content that responds to gesture, voice, or touch inputs. Based on the user input and determined interaction intent, the computing system 106 dynamically executes corresponding actions such as triggering content playback, modifying overlay elements, or activating additional virtual components, thereby updating and rendering the mixed reality content in real-time to maintain seamless interaction continuity.

The processor 202 executes an instruction that causes the transformation module 216 to transform the mixed reality content to obtain the user interaction enabled mixed reality content. The user interaction enabled mixed reality content is obtained by superimposing the one or more transparent video overlays. The one or more transparent video overlays include the one or more virtual elements. The one or more virtual elements are overlaid onto a real-time view of an environment captured by a camera module of the camera module 104a of the communication device 104. In an embodiment, the transformation module 216 initiates the transformation process immediately upon identification of the at least one mixed reality (MR) module. The transformation module 216 is configured to communicate with the orchestrator module 214 to transmit the transformed MR content. This enables the dynamic loading and subsequent deployment within the computing system 106.

In an embodiment of the present disclosure, the one or more transparent video overlays includes the alpha channel video overlay. The alpha channel video overlay preserves the background transparency of the real-time view of the physical environment. The real-time view of the physical environment is captured by the camera module 104a of the communication device 104. In an embodiment of the present disclosure, the alpha channel video overlay enables the selective visibility of the one or more virtual elements. In an embodiment of the present disclosure, the alpha channel video overlay preserves the visibility of the real-time imagery of the physical environment captured by the camera module 104a. In an embodiment of the present disclosure, the one or more virtual elements are integrated onto the real-time view captured by the camera module 104a of the communication device.

The one or more virtual elements refer to digitally generated graphical, textual, audio-visual, or interactive components that are superimposed onto the real-time view of the physical environment within the mixed reality (MR) experience. The one or more virtual elements are part of the transformed MR content and are rendered to appear spatially or contextually integrated with the real world as perceived through the communication device's camera module 104a. In various embodiments, the one or more virtual elements may include, but are not limited to 3D objects or models, 2D graphical overlays, instructional or descriptive text anchored to real-world features, gesture- or voice-interactive elements, multimedia components and adaptive user interface components. Example of the 3D objects or models include virtual furniture, animated characters, equipment overlays and the like. Examples of the 2D graphical overlays include buttons, icons, labels, or menus. Examples of the gesture- or voice-interactive elements include dynamic tooltips, navigation guides, and the like. Examples of the multimedia components include embedded videos or sound cues triggered by interaction. In an example, the adaptive user interface components modify their structure or layout based on user input or environmental context. The one or more virtual elements are configured to respond to user interactions and may vary in type, behavior, orientation, opacity, or spatial anchoring based on the specific MR content being delivered, the detected usage context, and the transformation process performed by the computing system 106.

Each of the plurality of triggering actions is pre-configured to retrieve or access interaction-enabled mixed reality content. In an embodiment, the metadata embedded within the universal access link associated with each triggering action includes information necessary to identify, retrieve, and initiate the corresponding interaction-enabled MR experience. The metadata includes a unique MR experience identifier, which corresponds to a specific MR content instance designed to support user interaction. Additionally, the metadata may include references to one or more assets such as 3D models, transparent video overlays, or interaction scripts required for rendering and delivering a complete interaction-enabled MR experience on the communication device 104.

In an implementation, the computing system 106 interacts with the server 114 and the database 116 to enable dynamic deployment of the required mixed reality modules and assets. Upon detection of the triggering action, the computing system 106 transmits a request based on the embedded metadata associated with the triggering action. The request is transmitted for downloading one or more modules and corresponding assets necessary to facilitate the interaction with the mixed reality content. The computing system 106 dynamically identifies at least one suitable mixed reality module from the plurality of MR modules 110 for deployment. In an embodiment, this includes identifying or selecting an interactions module, which is specifically configured to implement an interaction mechanism over the MR content.

The interaction mechanism is governed by an adaptive user interface (UI) framework, which dynamically generates and renders the user interface in the mixed reality environment. The adaptive UI framework is capable of tailoring the interface presentation in real-time based on user behavior, context, and received input. Additionally, the computing system 106 manages the efficient delivery of these modules, ensures appropriate configuration of runtime execution environments, and supports consistent performance across heterogeneous hardware platforms.

In an embodiment, prior to receiving user input, the computing system 106 performs an initial transformation of the mixed reality content. This transformation results in a pre-optimized and interaction-ready version of the MR content, which may be pre-stored in the database 116. The initial transformation utilizes at least the identified mixed reality modules, including the interactions module, and is executed independently of any real-time user interaction. This pre-optimized content includes the adaptive user interface composed of one or more virtual elements superimposed onto a real-time view of the user's physical environment as captured by the device's camera. The configuration of these virtual elements including their type, spatial placement, and orientation is determined based on the characteristics of the selected MR content and contextual parameters. This pre-rendered state serves as the foundational interface for subsequent interactive experiences.

In an embodiment of the present disclosure, the computing system 106 enables the interaction and executes the rendering of the mixed reality content using the dynamic module identification and loading approach. The dynamic module identification and loading approach ensures only relevant modules are deployed for enabling the interaction with the mixed reality content. The dynamic identification and execution approach enables seamless rendering of the mixed reality content. The computing system 106 utilizes the dynamic identification and execution approach to ensure timely, context-aware rendering.

Furthermore, the processor 202 executes an instruction that causes the rendering module 224 to render the transformed mixed reality content on the communication device 104. The rendering module 224 is configured to process the transformed MR content, which includes the one or more virtual elements superimposed on the real-time view of the physical environment captured by the device's camera module 104a.

The one or more virtual elements may include interactive UI components, annotations, or context-specific digital overlays. Upon execution, the computing system 106 presents the transformed MR content to the user 102 via a display interface of the communication device 104. The computing system 106 ensures precise alignment and synchronization of the one or more virtual elements with the physical surroundings. This initial rendering phase establishes a visually coherent and interaction-ready MR experience, serving as a baseline for subsequent optimization based on user input.

In an implementation, the rendering module 224 receives the transformed MR content prepared by the transformation module 216 and loaded through the orchestrator module 214. The rendering process leverages the capabilities of the device's graphical processing unit (GPU) and other hardware accelerators to ensure smooth and latency-free visualization of the MR content. In an embodiment, the rendering module 224 utilizes spatial mapping data and sensor inputs to align the one or more virtual elements accurately within the physical environment. The rendering module 224 ensures that the one or more virtual elements appear anchored, occluded, or interactive based on their intended behavior. The one or more virtual elements may include adaptive user interface components, object annotations, gesture-activated buttons, 3D assets, contextual labels, or animation overlays, each tailored to the MR experience being accessed.

The initial rendering phase constitutes the pre-interaction state of the MR experience. The initial rendering phase presents the user 102 with a baseline, interaction-enabled interface that is visually coherent and responsive, but not yet customized based on actual user input. The computing system 106 ensures real-time responsiveness, adaptive resolution scaling, and seamless blending of the one or more virtual elements with a camera feed. Additionally, the rendered output may account for orientation of the device, and detected surfaces or planes to maintain realism and user immersion.

Once rendered, the mixed reality content remains dynamically updateable. The rendering module 224 remains in an active state to receive instructions from other modules, allowing for re-rendering or updating the displayed MR scene (explained below).

Next, the processor 202 executes an instruction that causes the receiving module 218 to receive the user input for interacting with the user interaction enabled mixed reality content. In an embodiment, the receiving module 218 detects and captures the user input intended for interacting with the user interaction-enabled mixed reality content. The interaction is facilitated through the one or more virtual elements that are superimposed on the real-time view of the physical environment. The one or more virtual elements serve as interaction affordances or interface components that the user 102 can engage with to perform specific actions within the MR environment.

In an embodiment of the present disclosure, the user input is received through the communication device 104. In an embodiment of the present disclosure, the receiving module 218 utilizes on-board input sensors and interfaces of the communication device 104, to collect the user input in real-time. The user input includes one of a gesture-based input, a voice-based input, a touch-based input or a text-based input.

In an example, the gesture-based input is captured through the device's camera(s) and/or motion sensors, allowing the user 102 to interact using hand or body movements. In an example, the voice-based input is received through the device's microphone(s) and interpreted using integrated or cloud-based voice recognition mechanisms. In an example, the touch-based input may involve taps, swipes, or multi-touch gestures performed directly on the device's touchscreen. In an example, the text-based input may be entered through an on-screen or physical keyboard and used to issue commands or supply contextual information. The receiving module 218 pre-processes and packages the captured input for analysis, ensuring accurate interpretation of the user's interaction intent in coordination with the analysis module 220.

Further, the processor 202 executes an instruction that causes the analysis module 220 to analyze the received user input to determine an interaction intent associated with the mixed reality content. The interaction intent represents a specific type of action or engagement that the user 102 wishes to perform within the MR environment. In an example, the interaction intent may include selecting an object, opening an interface, triggering an animation, or navigating through content layers.

In an embodiment of the present disclosure, the analysis module 220 determines the interaction intent by interpreting both the modality and context of the user input. Specifically, the analysis module 220 identifies the type of input (e.g., gesture, voice, touch, or text) and correlates the type of input with a corresponding virtual element from the one or more virtual elements rendered within the MR scene. The virtual element serves as a reference point or actionable component in the MR interface, and the virtual element's correspondence with the input modality is key to deducing the user's interaction intent.

In an embodiment, the recognition of the relevant virtual element varies depending on the type of input. The corresponding virtual element is recognized for each type of the user input in a different way. In the case of the gesture-based input, the analysis module 220 compares the detected gesture against a pre-defined set of gesture templates. Each of the plurality of gestures is assigned to a corresponding interaction intent. Specifically, each gesture is mapped to a distinct interaction intent. For example, a pinching gesture may be associated with zooming, while a swiping gesture may represent navigation.

In the case of the touch-based input, the analysis module 220 identifies a precise location or coordinates on the spatial map of the physical environment where the touch occurred. The analysis module 220 maps the touch point to the spatial position of the one or more virtual elements in the mixed reality scene. The mapping is done to determine which virtual element has been selected by the user 102. Accordingly, the analysis module 220 infers the intended interaction based on the determined virtual element.

Similarly, in the case of the voice-based input, the analysis module 220 processes a spoken command using natural language processing and intent recognition techniques to map the utterance to a supported MR action. In case of the text-based input scenarios, the analysis module 220 parses and semantically analyzes user-entered keywords or commands to derive the interaction intent relative to the available virtual elements.

In an embodiment of the present disclosure, the computing system 106 employs a color mapping technique to facilitate precise interaction handling based on the touch input. The color mapping technique involves use of a color map image. The color map image serves as a hidden interaction layer. The color map is rendered in parallel with the visible mixed reality (MR) scene on a canvas element. The color map remains invisible to the user 102 on the display of the communication device 104. The color map is spatially and geometrically aligned with the real-time video stream or the rendered MR content. In an embodiment, each pixel in the color map corresponds directly to a pixel in the MR scene, maintaining one-to-one mapping on a same coordinate plane. In an example, the image typically contains color-coded zones, where each unique color represents a specific virtual element or interactive region within the MR environment.

In an example, when the user 102 touches the screen, the computing system 106 records precise coordinates of the touch event. Accordingly, the computing system 106 references the color map at the recorded coordinates to determine the corresponding virtual element or interaction target in 3D space. This allows the computing system 106 to infer the user's interaction intent with high spatial accuracy, even in complex, depth-aware MR environments where virtual elements may overlap or appear in layers. The color map does not interfere with the user's visual experience as it is rendered invisibly and only used for internal interaction resolution.

In an embodiment of the present disclosure, the computing system 106 determines the interaction intent for the text-based input and the voice-based input through natural language processing (NLP) algorithms. In an example, when a user provides a text input, the computing system 106 analyzes the input using NLP techniques to identify one or more relevant keywords or phrases. These keywords are then semantically mapped against a pre-defined set of keywords or tags associated with individual virtual elements rendered within the mixed reality (MR) scene. The mapping helps the computing system 106 infer which specific virtual element the user intends to interact with and what type of interaction is being requested (e.g., expand, rotate, retrieve more information, etc.).

In an embodiment, for voice-based input, the computing system 106 first converts an audio signal into text using automatic speech recognition (ASR) techniques. Once transcribed, the resulting text undergoes the same NLP-based keyword recognition process. The identified keywords from the voice input are matched against the corresponding set of keywords assigned to the one or more virtual elements overlaid on the MR content. In an embodiment, each virtual element in the scene may be annotated with metadata specifying command-sensitive actions. For instance, if a virtual product display is overlaid in the MR view, and the user says, “show price,” the keyword “price” would be matched against the pre-defined interaction options for that product element.

Next, the processor 202 executes an instruction that causes the optimization module 222 to dynamically optimize the mixed reality content. The mixed reality content is optimized based on the determined interaction intent by executing the one or more actions on the mixed reality content. The one or more actions correspond to pre-stored actions to be taken for optimizing the mixed reality content. The one or more actions are pre-configured in the identified or determined at least one mixed reality module. In an example, the at least one identified mixed reality module includes the interactions module and/or other modules. The actions are preconfigured in the identified mixed reality modules for specific functionalities corresponding to the interactions module. The interactions module is configured to enable execution of a particular action in response to the user input. In an embodiment, the user input is mapped to the particular action based on the spatial map. In an embodiment, the optimization module 222 may utilize one or more modules such as 2D modules, 3D modules and assets modules in combination with the interaction modules depending on the user input and corresponding actions to be executed in response to the user input.

In an embodiment of the present disclosure, the optimization of the interaction experience is done by executing a series of steps. The series of steps includes a first step of analyzing at least one of the user interaction data, the user movement data and the environmental data. The analysis is done during the interaction of the user 102 with the one or more virtual elements rendered within the mixed reality content. The series of steps includes a second step of prioritizing at least one of the type of user interaction and the layout type of the one or more virtual elements based on the analysis. The series of steps includes a third step of rendering the mixed reality content with the optimized user interface based on the prioritizing.

In an embodiment of the present disclosure, the user interaction with the one or more transparent video overlays can occur through the user input. The user input triggers an interaction which subsequently triggers the one or more actions within the app. In an example, the one or more actions may include starting the video from a specific time point, changing the overlay content, or activating other interactive elements.

The computing system 106 enables interaction with the mixed reality content using the one or more transparent video overlays. The computing system 106 renders the one or more transparent video overlays over the real-time view and allows users to interact with the one or more transparent video overlays using any type of input. The interaction triggers events within the application. In an embodiment of the present disclosure, the one or more transparent video overlays include an Alpha Channel Video Overlay. The Alpha Channel Video Overlay allows a transparent video to be superimposed on the real-time view captured by a device's camera (the camera module 104a). The Alpha Channel Video Overlay can be used to add virtual elements to the environment or enhance existing features. Key features of the Alpha Channel Video Overlay include transparency support, utilizing videos with an alpha channel to render transparent or semi-transparent overlays and real-time rendering. The overlays are adjusted to the camera's perspective and movement, and virtual element integration. The overlays represent virtual objects, characters, or informational content that seamlessly blend with the real world. For instance, in an MR shopping app, a user can see how a piece of furniture would look in their room by viewing a transparent 3D model overlaid on their camera feed, or by viewing an experience for an advertisement in a newspaper.

In an embodiment, the computing system 106 enables gesture recognition, which detects swipes, taps, and pinches to interact with virtual elements. In an embodiment, the computing system 106 enables the touch inputs which allow direct manipulation of overlays through touch-screen interfaces. In an embodiment, the computing system 106 enables event triggers that can start videos from specific timestamps, change overlay content, or activate other interactive elements. For example, in a mixed reality-based newspaper advertisement app, a user taps on a transparent overlay of a product figure, triggering a video (an action) that provides more information about the product. Swiping left or right could switch between different figures or topics, or tapping on a certain region could switch the entire video context.

The processor 202 executes an instruction that causes the rendering module 224 to render the optimized mixed reality content on the communication device 104. The rendering of the optimized mixed reality content includes rendering at least one digital object within the physical environment on the display of the communication device 104 based on the spatial map. The digital object is visually aligned with the real-time camera view captured by the camera module 104a of the communication device 104. The mixed reality content is updated and rendered continuously based on the incremental user inputs to enable the seamless interaction of the user 102 with the mixed reality content. In an embodiment of the present disclosure, the mixed reality content is rendered using the adaptive user interface framework that dynamically adjusts the layout and the interaction model. The adjustment is done based at least on the user interaction history, the device type, and the environmental conditions. In an embodiment of the present disclosure, enabling the seamless interaction with the rendered mixed reality content includes simulating realistic physical responses on a rendered digital object. The seamless interaction is enables based on the user input and changes in the physical environment.

In an embodiment of the present disclosure, the execution of the computer-implemented method results in hardware-level coordination among a processor, memory, display unit, and the camera module 104a of the communication device 104. The hardware-level coordination facilitates real-time balancing of graphical and computational workloads during the transformation, the rendering, and the continuous updating of the mixed reality (MR) content. The processor dynamically allocates the processing cycles between the image processing, the overlay rendering, and the user-input detection. The memory caches the transient video overlay data to ensure uninterrupted playback. The integrated hardware-level workflow reduces data transfer latency, minimizes frame drop occurrences, and maintains real-time alignment of the transparent video overlays with the physical environment. Consequently, the coordinated execution achieves reduced rendering latency, improved frame stability, and enhanced spatial coherence between the virtual and the real-world visual elements.

In an embodiment of the present disclosure, the computing system 106 adjusts the one or more transparent video overlays in real-time. The adjustment is done based at least on the real-time data from the camera module 104a and the real-time user movement data. The adjustment is done to enable the spatial alignment of the one or more virtual elements with the physical environment.

In an embodiment of the present disclosure, the computing system 106 anchors the one or more virtual elements persistently within the physical environment. The anchoring includes a series of steps. The series of steps includes a first step of identifying one or more physical surfaces in the physical environment and contextually placing the one or more virtual elements relative to the one or more physical surfaces. The series of steps includes a second step of generating a visual preview of the one or more virtual elements overlaid in the physical environment. The series of steps includes a third step of dynamically adjusting the spatial position of the one or more virtual elements based on the user input. The series of steps includes a fourth step of tracking the user movement using data from the camera sensor. The series of steps includes a fifth step of dynamically updating at least one of the positioning, the orientation, and the appearance of the virtual element in response to the user movement.

In an embodiment, the spatial map of the physical environment is generated by applying computer vision algorithms on the camera input. The spatial map of the physical environment represents surfaces, objects, and the user context. The spatial map is continuously updated in real-time. The rendered MR content includes alpha channel video overlays, interactive 3D objects, or other visual elements aligned with the device's real-time camera feed. The alpha channel video overlays are responsive to various user inputs, including touch, voice, motion, gaze, and gestures.

To enhance security and performance, the plurality of MR modules 110 are executed within the secure sandboxed environment at a kernel level of a Linux-based operating system of the communication device 104. The computing system 106 is configured to enable seamless playback and interaction with the rendered MR content on the communication device 104.

In an embodiment of the present disclosure, the modular mixed reality engine 108 dynamically loads and unloads the mixed reality modules based on the user interactions, the environmental data and the hardware capabilities. In an example, only relevant mixed reality components are active at any given time, which optimizes memory and compute resource usage, reducing lag or delay in rendering. The real-time orchestration prevents bottlenecks and enables continuous, uninterrupted MR experiences.

In an embodiment of the present disclosure, the computing system 106 utilizes a feedback loop to enhance the immersive experience. The user 102 engages or interacts with the mixed reality content. The computing system continuously collects and analyzes data regarding the user interactions, movements, and environmental conditions. The real-time feedback informs the computing system 106 of user preferences, behavioral patterns, and situational context. Accordingly, the computing system 106 optimizes the mixed reality content to adapt itself by altering the one or more virtual elements, adjusting difficulty levels, or providing tailored narratives to enhance user engagement and satisfaction.

For instance, if a user demonstrates a preference for specific types of interactions or exhibits certain behaviours, the computing system 106 can adjust the mixed reality experience to prioritize those elements, thereby creating a more personalized and engaging environment. This adaptive process not only enhances the user experience but fosters deeper immersion by ensuring that the mixed reality content remains relevant and responsive to individual user needs. The continuous feedback loop ensures that the mixed reality experience evolves in real-time, maximizing engagement and retention.

In an embodiment of the present disclosure, the computing system 106 is configured to predict one or more potential user actions by analyzing historical patterns. The historical patterns include past user interactions, previously observed behavior, interaction types, and contextual usage trends. Based on the predictions, the computing system proactively pre-loads one or more mixed reality (MR) components. The one or more mixed reality (MR) components include MR modules and associated virtual assets that are likely to be required to support the anticipated user actions. The predictive pre-loading mechanism reduces response latency and significantly improves the perceived responsiveness and fluidity of the mixed reality experience.

The predictive model is continuously refined and updated in real-time by leveraging ongoing data collected from current user interactions. The real-time feedback loop allows the computing system 106 to dynamically adapt the predictions based on evolving user behavior and environmental context. For instance, if a user consistently interacts with specific virtual elements during a particular scenario such as examining a product label or manipulating a 3D object, the computing system 106 learns these preferences and prepares the relevant components in advance.

In an embodiment, the computing system 106 continuously monitors live user interaction data in conjunction with the physical environmental data, such as device orientation, and proximity information, to infer the user's situational context. The computing system 106 uses these insights and determines the most relevant MR modules, including the interactions module, which are necessary for delivering the expected user experience.

In an embodiment, prior to module deployment, the computing system 106 assesses the device resource availability by evaluating parameters such as CPU and GPU load, battery state, network bandwidth, and thermal thresholds. This ensures that the predicted MR components are only deployed when adequate system resources are available, thereby preventing performance degradation.

In an embodiment, the computing system 106 dynamically loads or unloads MR modules within a secure, kernel-level sandboxed execution environment based on the prediction results and resource evaluation. This enables efficient resource allocation while maintaining system stability and ensuring secure execution of MR components across heterogeneous devices.

In an example, in a retail furniture environment, a user X (hereinafter referred to as “X”) enters a store and becomes interested in a displayed sofa. X scans a Quick response (QR) code embedded on the sofa's price tag using a smartphone, which serves as a triggering action that activates the MR experience. Upon detecting this triggering action, the modular mixed reality engine 108 is invoked via the dynamic module identification and execution approach. The modular mixed reality engine 108 selectively loads only the necessary mixed reality (MR) modules, such as a texture mapping module, a color adjustment module, and the interactions module, while offloading irrelevant modules to optimize resource usage on the communication device 104. As X engages with the mixed reality experience, 2D alpha-channel overlays appear over the live camera view. These overlays represent virtual elements corresponding to fabric swatches and color options. When X taps on a virtual fabric overlay, the interactions module captures the input, and the cross-module communication enables the 3D rendering module to update the sofa's appearance in real-time, reflecting the selected fabric. To enhance user engagement and reduce latency, the predictive preloading system within the computing system 106 analyzes the interaction context and anticipates that X may explore additional related items. The computing system 106 then preloads modules and assets for visually compatible furniture pieces such as coffee tables and rugs. This ensures that if X selects one of these categories, the experience transitions seamlessly without perceptible delay. Further, the adaptive user interface framework adjusts visual fidelity in real-time. For instance, if X zooms in or focuses on finer details of the sofa, the computing system 106 dynamically switches to high-resolution textures. The rendering quality is adapted based on real-time network conditions, ensuring uninterrupted experience even under constrained bandwidth. To handle computationally intensive rendering tasks while preserving the mobile device's performance, the computing system 106 utilizes edge computing resources. These remote compute nodes handle tasks like high-fidelity model rendering, allowing X's device to maintain smooth, low-latency interactions throughout the MR session.

In an example implementation, the computing system 106 is configured to simulate realistic physical responses of virtual objects based on the user inputs and the changes in the physical environment. The simulation is done to ensure seamless playback and natural interaction with the rendered mixed reality content. Upon receiving the interaction input (e.g., a touch-based gesture on a virtual ball overlaid on a real-world table), the computing system 106 interprets the input's spatial parameters such as position, direction, and intensity. The rendering module 224, along with a specialized logic within the modular transformation framework, simulates a corresponding physical reaction. The reaction causes the virtual ball to roll or bounce across a table surface in a manner consistent with real-world physics.

Additionally, the computing system 106 dynamically adapts the behavior of the virtual object to real-world conditions. For example, if the device sensors detect that the physical table is tilted, the computing system 106 recalculates the ball's motion trajectory to match the incline, ensuring continuity between the digital overlay and the physical context. The real-time alignment of virtual responses with environmental factors enhances immersion and realism, delivering an intuitive and responsive MR experience tailored through dynamic module orchestration.

In an embodiment of the present disclosure, execution of the computer-executable instructions stored in the memory 204 by the one or more processors improves the operation of the communication device 104 by reducing the computational cycles required for rendering the user-interaction-enabled mixed reality content. The improvement is achieved through the adaptive resource allocation. The one or more processors continuously assess the hardware parameters of the communication device 104, such as the CPU utilization, the GPU bandwidth, the memory availability, and the camera-processing load. Based on the real-time assessment, the computing system 106 dynamically adjusts the rendering fidelity, the transparent-overlay compositing priority, and the interaction-processing intensity across the hardware subsystems. The adaptive management of the hardware resources minimizes redundant computation and enables efficient execution of interactive mixed-reality rendering operations.

In an embodiment, the real-time adaptive resource allocation performed by the one or more processors enhances the system responsiveness and graphical stability when processing continuous user interactions. The computing system 106 intelligently distributes workloads between the CPU and GPU by prioritizing the interaction-critical processes, such as gesture recognition, hit-testing, overlay compositing, and the spatial alignment of the one or more virtual elements. Non-critical graphical updates are selectively deferred to maintain consistent frame pacing. The coordinated execution between the processing subsystems reduces the frame-level latency, prevents visual jitter, and improves synchronization between the rendered one or more overlays and the camera feed. As a result, the communication device 104 achieves smooth and stable mixed-reality performance even when executing high-frequency interaction events on devices with limited processing capability.

In an embodiment of the present disclosure, the computing system 106 includes the one or more processors and the memory 204 configured to cooperatively execute the interaction-enabled mixed reality pipeline. The one or more processors coordinate with the display hardware and the camera module 104a to orchestrate concurrent processing of the interaction data, the transparent-overlay compositing, and the real-time camera imagery. The one or more processors monitor the hardware utilization parameters such as memory throughput, camera frame-rate stability, and display-refresh latency to determine the optimal scheduling of the image-processing and interaction-rendering tasks. The system-level coordination maintains visual continuity under varying hardware load conditions and improves the consistency of the spatial alignment between the one or more virtual elements and the real-time view.

In an embodiment, the computing system 106 utilizes the adaptive control mechanism to modify the rendering fidelity, the overlay-blending precision, and the interaction-processing priority based on the real-time detection of the hardware capabilities and the environmental conditions. Under high-load scenarios, the computing system 106 reduces the non-essential rendering updates such as secondary animation layers or low-priority virtual-element effects to ensure uninterrupted responsiveness to the user input. When additional computational capacity is available, the computing system 106 enhances the interaction quality by activating higher-fidelity graphical transitions and improved spatial smoothing. The adaptive control reduces the overall system latency, improves the visual fluidity, and ensures precise alignment between real-world movement and the user-interaction-enabled virtual content.

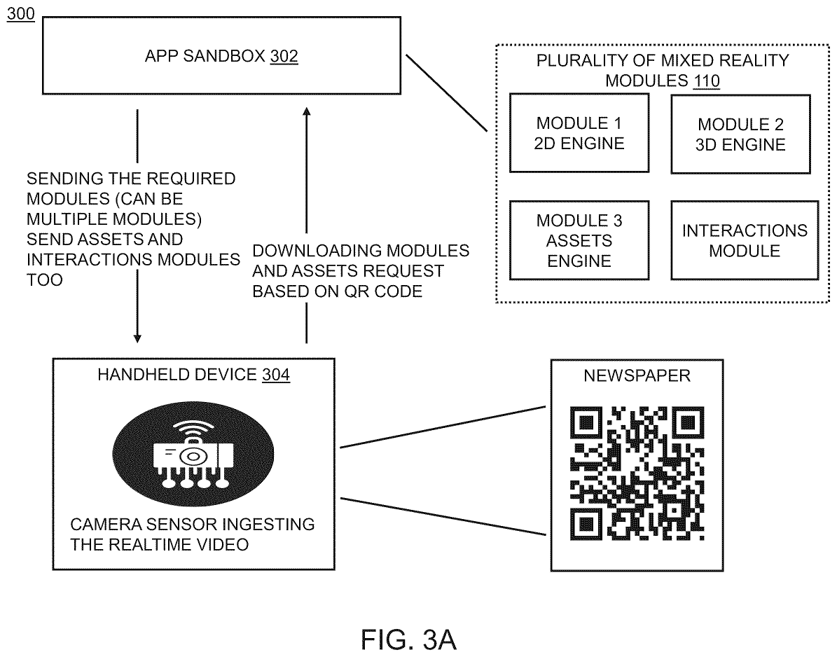

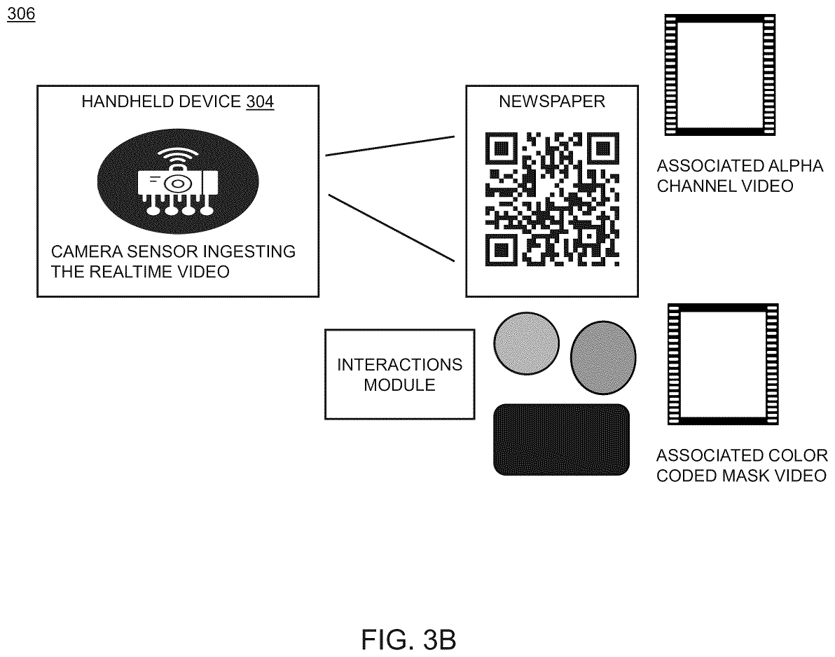

FIG. 3A illustrates an exemplary environment 300 for enabling trigger-based instantiation and modular deployment of mixed reality content on a handheld device, in accordance with an embodiment of the present disclosure. Specifically, the exemplary environment 300 depicts a computing system for downloading of modules. The exemplary environment 300 depicts downloading of an application sandbox at run time without downloading an instant application, in accordance with an embodiment of the present disclosure. The application sandbox includes one or more mixed reality modules configured to optimize the mixed reality content. The mixed reality content is optimized by superimposing the one or more transparent video overlays. The one or more transparent video overlays include the one or more virtual elements. The one or more virtual elements are overlaid onto the real-time view of the environment captured by the camera module 104a of the communication device 104 (as explained above in the detailed description of FIG. 1 and FIG. 2).

The exemplary environment 300 depicts an example of a workflow for downloading the application sandbox from an application sandbox server 302. The application sandbox server 302 stores the plurality of mixed reality modules 110. The application sandbox is downloaded from the application sandbox server 302. The application sandbox contains one or more modules. The one or more modules enable the interaction with the mixed reality content on a handheld device 304. In an example, the application sandbox server 302 is equivalent to the server 114 and the handheld device 304 is equivalent to the communication device 104 shown in FIG. 1.

The application sandbox server 302 is communicatively coupled to the computing system 106. The computing system 106 enables the dynamic optimization of the mixed reality content at the handheld device 304. In addition, the mixed reality content is optimized in real-time. A user associated with the handheld device 304 can interact with the mixed reality content in real-time.

The exemplary environment 300 depicts the handheld device 304 displaying the mixed reality content. The mixed reality content is executed within an application sandbox environment. The handheld device 304 may be a smartphone, a tablet, or a wearable computing device. The handheld device 304 includes a camera sensor configured to capture real-time video frames of a physical environment. In the depicted embodiment, a physical medium, such as a printed newspaper, includes an image trigger, for example, a Quick response (QR) code, bar code, visual glyph, or any computer-vision-recognizable pattern.

Upon ingestion of the image trigger through the camera sensor, the application executing within the sandbox parses and identifies the trigger, thereby initiating a content request to the remote application sandbox server 302. The request includes at least one module and asset retrieval directive based on the specific image trigger identified.

The application sandbox server 302 orchestrates the retrieval and transmission of the one or more modules and associated assets to the handheld device 304. As illustrated, the application sandbox server 302 may include the plurality of mixed reality modules 110. As shown in the exemplary environment 300, the plurality of mixed reality modules 110 include module 1 (2D engine), module 2 (3D engine), module 3 (assets engine), and interactions module. In an embodiment, the plurality of mixed reality modules 110 are not limited to the above mentioned modules. In this example, the module 1 is configured to process and render two-dimensional content layers in the MR environment. The module 2 is configured to process and render three-dimensional spatial content. The module 3 is configured to retrieve, manage, and serve graphical assets, such as textures, meshes, audio files, and animation sequences. The interactions module is configured to enable and manage user interaction mechanisms, such as gesture-based input, touch input, gaze detection, or voice input, in coordination with rendered content.

Following transmission, the handheld device 304 dynamically loads and executes the received modules and assets within the device's sandboxed runtime environment.

The exemplary environment 300 allows for selective instantiation of only the components required for a given trigger context, thereby reducing computational overhead, memory usage, and network bandwidth consumption. In the context of the present disclosure, the exemplary environment 300 allows for selective instantiation of the components required for enabling the interaction mechanism on the mixed reality content rendered on the handheld device 304.

FIG. 3B illustrates an exemplary environment 306 depicting a computing system for downloading of interaction modules and associated visual assets, in accordance with an embodiment of the present disclosure. The exemplary environment 306 depicts the computing system for contextual downloading and deployment of one or more interaction modules on the handheld device 304.

The computing system 106 enables the downloading of the interaction modules and the associated visual assets through a process. The process includes a first step to initiate the detection of the triggering action at the handheld device 304. The triggering action may include scanning a marker, opening the hyperlink, or performing a context-aware interaction. Upon detection, the computing system identifies an MR experience identifier embedded within the universal access link associated with the triggering source.

The process includes a second step to extract metadata associated with the MR experience, which may include a reference to the relevant interaction modules, an alpha channel video, and a corresponding color-coded mask video. The alpha channel video represents a transparent or semi-transparent video layer superimposed on the real-time view. The color-coded mask video provides region-specific color segmentation to enable precise interaction mapping within the rendered mixed reality content.

The process includes a third step to transmit a structured request to the server 114 for dynamic retrieval of the one or more interaction modules, along with the one or more modules related to the associated visual assets. The request parameters are generated based on the usage context, the device capabilities, and the embedded metadata.

The process includes a fourth step to enable backend-side orchestration, where the server selects appropriate interaction modules and linked video assets by analyzing contextual data and the MR experience identifier. The selected assets include the alpha channel video and the color-coded mask video. The assets are transmitted to the handheld device 304 in a resource-optimized format.

The process includes a fifth step to dynamically load the received interaction modules within the secure execution environment (e.g., kernel-level sandbox), and simultaneously deploy the alpha channel video and the color-coded mask video onto the rendering canvas of the handheld device 304. The alpha channel video ensures seamless overlay of the one or more virtual elements with preserved transparency. The color-coded mask enables pixel-level touch or gesture-based interaction by mapping user inputs to specific regions or objects in the MR experience. This integrated mechanism facilitates context-aware, interaction-enabled rendering of mixed reality content in real-time.

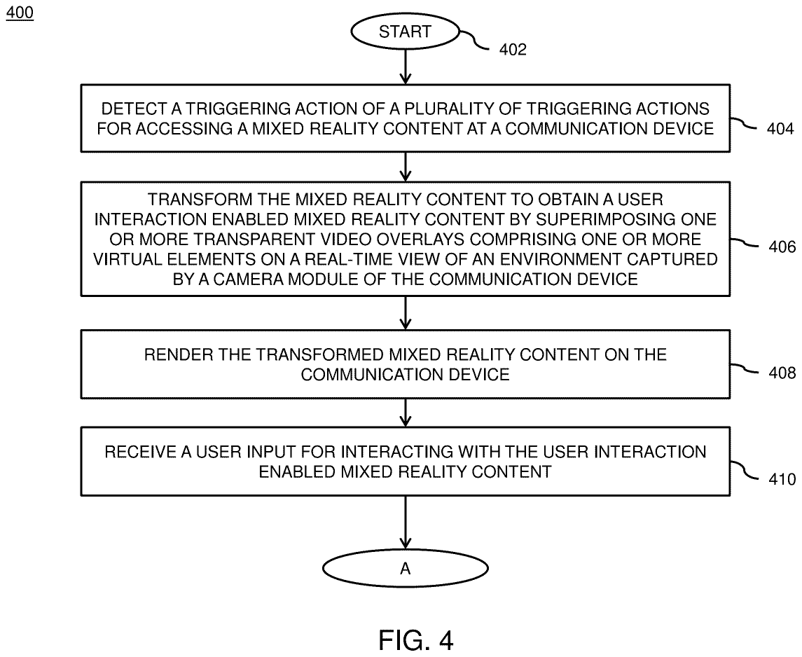

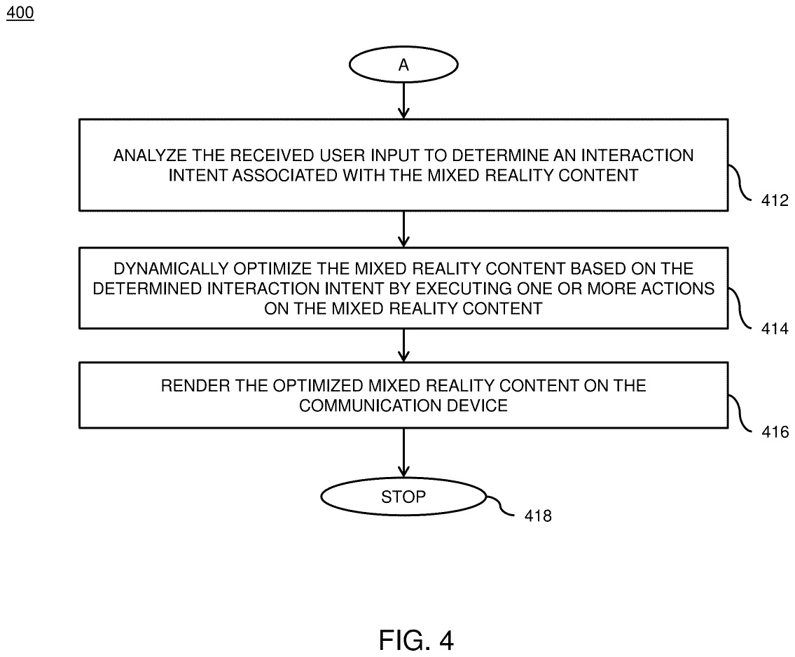

FIG. 4 illustrates a flow chart 400 of a method for enabling the interaction with the mixed reality content, in accordance with various embodiments of the present disclosure. The method enables the rendering of the mixed reality content at the communication device 104. In addition, the method enables optimization of the mixed reality content in real-time. The mixed reality content is optimized by superimposing the one or more transparent video overlays. The one or more transparent video overlays include the one or more virtual elements. The one or more virtual elements are overlaid onto the real-time view of the environment captured by the camera module 104a of the communication device 104. Further, the method enables the user 102 to interact with the mixed reality content in real-time (as explained above in the detailed description of FIG. 1 and FIG. 2). It may be noted that the description of the flowchart 400 refers to FIG. 1, and FIG. 2. The working and functioning may be read from the description of FIG. 1, and FIG. 2.

The flowchart 400 initiates at step 402. At step 404, the method includes the detection of the triggering action of the plurality of triggering actions for accessing the mixed reality content at the communication device 104. In an embodiment of the present disclosure, the plurality of triggering actions corresponds to the mode for initiating the device-agnostic access to the mixed reality content. In an embodiment, the plurality of triggering actions includes but may not be limited to scanning the Quick Response (QR) code, clicking the hyperlink, detecting the near-field communication (NFC) tag, receiving the voice command, or recognizing the gesture input. In an embodiment of the present disclosure, the Quick Response (QR) code may be captured through the camera module 104a of the communication device 104, decoded, and utilized to extract the metadata required for initializing the modular mixed reality engine 108.

At step 406, the method includes transforming the mixed reality content to obtain the user interaction enabled mixed reality content. The user interaction enabled mixed reality content is obtained by superimposing the one or more transparent video overlays. The one or more transparent video overlays include the one or more virtual elements. The one or more virtual elements are overlaid onto the real-time view of the environment captured by the camera module 104a of the communication device 104.

In an embodiment of the present disclosure, the one or more transparent video overlays includes the alpha channel video overlay. The alpha channel video overlay preserves the background transparency of the real-time view of the physical environment. The real-time view of the physical environment is captured by the camera module 104a of the communication device 104. In an embodiment of the present disclosure, the alpha channel video overlay enables the selective visibility of the one or more virtual elements. In an embodiment of the present disclosure, the alpha channel video overlay preserves the visibility of the real-time imagery of the physical environment captured by the camera module 104a. In an embodiment of the present disclosure, the one or more virtual elements are integrated onto the real-time view captured by the camera module 104a of the communication device.

At step 408, the method includes rendering the transformed mixed reality content on the communication device 104.

At step 410, the method includes receiving the user input for interacting with the user interaction enabled mixed reality content. The interaction is enabled through the one or more virtual elements. In an embodiment of the present disclosure, the user input is received through the communication device 104. The user input includes one of the gesture-based input, the voice-based input, the touch-based input or the text-based input.

At step 412, the method includes analyzing the received user input to determine the interaction intent associated with the mixed reality content. The interaction intent corresponds to a type of interaction that the user 102 wants to have with the mixed reality content. In an embodiment of the present disclosure, the interaction intent is determined by recognizing the type of the user input and the corresponding virtual element of the one or more virtual elements for interaction. In an embodiment, the corresponding virtual element is recognized for each type of the user input in a different way. In an embodiment, the gesture-based input can be provided through one particular gesture of a plurality of gestures. Each of the plurality of gestures is assigned to a corresponding interaction intent. In an embodiment, for the touch-based input, the interaction intent is determined based on an area or point on the spatial map where the user 102 has touched. Accordingly, the touch point is mapped for recognizing the particular virtual element overlaid on the corresponding touch point. In an embodiment, for the text-based input, the interaction intent is determined based on recognition of one or more keywords on the text input using natural processing algorithms. The one or more keywords may be matched with corresponding one or more keywords related to the particular virtual element overlaid on the mixed reality content. In an embodiment, for the voice-based input, the interaction intent is determined based on recognition of one or more keywords on the audio input using natural processing algorithms. The one or more keywords may be matched with corresponding one or more keywords related to the particular virtual element overlaid on the mixed reality content.

At step 414, the method includes dynamically optimizing the mixed reality content based on the determined interaction intent by executing the one or more actions on the mixed reality content. The one or more actions correspond to pre-stored action to be taken for optimizing the mixed reality content. The one or more actions are pre-configured in the identified mixed reality module. In an example, the identified mixed reality module corresponds to the interactions module. The interactions module is configured to execute a particular action in response to the user input. In an embodiment, the user input is mapped to the particular action based on the spatial map.

In an embodiment of the present disclosure, the optimization of the interaction experience is done by executing a series of steps. The series of steps includes a first step of analyzing at least one of the user interaction data, the user movement data and the physical environmental data. The analysis is done during the interaction of the user 102 with the one or more virtual elements rendered within the mixed reality content. The series of steps includes a second step of prioritizing at least one of the type of user interaction and the layout type of the one or more virtual elements based on the analysis. The series of steps includes a third step of rendering the mixed reality content with the optimized user interface based on the prioritizing.

At step 416, the method includes rendering the optimized mixed reality content on the communication device 104. The rendering of the optimized mixed reality content includes rendering at least one digital object within the physical environment on the display of the communication device 104 based on the spatial map. The digital object is visually aligned with the real-time camera view captured by the camera module 104a of the communication device 104. The mixed reality content is updated and rendered continuously based on the incremental user inputs to enable the seamless interaction of the user 102 with the mixed reality content. In an embodiment of the present disclosure, the mixed reality content is rendered using the adaptive user interface framework that dynamically adjusts the layout and the interaction model. The adjustment is done based at least on the user interaction history, the device type, and the physical environmental conditions. In an embodiment of the present disclosure, enabling the seamless interaction with the rendered mixed reality content includes simulating realistic physical responses on a rendered digital object. The seamless interaction is enabled based on the user input and changes in the physical environment.

In an embodiment of the present disclosure, the method includes adjusting the one or more transparent video overlays in real-time. The adjustment is done based at least on the real-time data from the camera module 104a and the real-time user movement data. The adjustment is done by enabling the spatial alignment of the one or more virtual elements with the physical environment.

In an embodiment of the present disclosure, the method includes anchoring the one or more virtual elements persistently within the physical environment. The anchoring includes a series of steps. The series of steps includes a first step of identifying the one or more physical surfaces in the physical environment and contextually placing the one or more digital objects relative to the one or more physical surfaces. The series of steps includes a second step of generating the visual preview of the one or more virtual elements overlaid in the physical environment. The series of steps includes a third step of dynamically adjusting the spatial position of the one or more virtual elements based on the user input. The series of steps includes a fourth step of tracking the user movement using data from the camera module 104a. The series of steps includes a fifth step of dynamically updating at least one of the positioning, the orientation, and the appearance of the digital object in response to the user movement.

In an embodiment of the present disclosure, the method enables the interaction and executes the rendering of the mixed reality content using the dynamic module identification and loading approach. The dynamic module identification and loading approach ensures only relevant modules are deployed for enabling the interaction with the mixed reality content. The dynamic identification and execution approach enables seamless rendering of the mixed reality content with each interaction based input from the user 102.

In an embodiment of the present disclosure, the mixed reality content is transformed and rendered by applying the dynamic module identification and loading approach. The dynamic module identification and loading approach includes activating the modular mixed reality engine 108 in response to the detected triggering action. The modular mixed reality engine 108 includes the plurality of mixed reality modules 110. The modular mixed reality engine 108 is activated based on the detection of the triggering action of the plurality of triggering actions at the communication device 104. The modular mixed reality engine 108 includes the plurality of mixed reality modules 110.

Next, the dynamic identification and execution approach includes recognizing the usage context-based on the hardware capabilities of the communication device 104, the environmental data and the embedded metadata associated with the detected triggering action in real-time. Recognizing the usage context includes continuously assessing device resource availability based on a set of parameters. The set of parameters includes at least CPU utilization, GPU utilization, battery state, network state and thermal limits. Further, the embedded metadata is utilized for determining a particular mixed reality content requested for access through the mixed reality experience ID. In addition, the embedded metadata contains a request for rendering the mixed reality content with interaction ability.

Next, the dynamic identification and execution approach includes identifying at least one mixed reality (MR) module from the plurality of mixed reality modules 110 based on the usage context recognition in real-time. In an embodiment, the at least one mixed reality (MR) module includes at least one of an interactions module and assets modules for enabling the transformation of the mixed reality content. In an embodiment, the at least one mixed reality (MR) module is identified based on one or more pre-defined criteria. The one or more pre-defined criteria used for selecting the at least one mixed reality module are associated with one or more features of the communication device 104. The one or more features include the type of the communication device 104 and the hardware capabilities of the communication device 104. In addition, the one or more features include the operating system specifications of the communication device 104 and the types of sensors in the communication device 104. Further, the one or more features include the rendering capacity of the communication device 104.

Next, the dynamic identification and execution approach includes dynamically loading and deploying the at least one identified mixed reality module within the secure execution framework. The dynamic loading enables rendering of the mixed reality content with the interaction enabled one or more virtual elements on the communication device 104. In an embodiment, the dynamic loading of the at least one identified mixed reality module is done through the instant application mechanism. The instant application mechanism enables temporary deploying the instant application on the communication device 104. In an embodiment, the instant application has a pre-defined size ranging from 900 kilobytes to 1.2 megabytes. In an embodiment, the instant application size may be less than 900 kilobytes. The orchestrator module 214 dynamically loads the at least one mixed reality (MR) module in real-time based on the usage context. The at least one module operates within the kernel-level application sandbox in the Linux-based system to ensure both performance and security.

The flowchart 400 terminates or ends at step 418.

The present disclosure provides a tangible improvement in real-time mixed reality rendering by optimizing the hardware utilization during the interaction processing. The disclosed system 106 reduces the computational overhead, enhances the synchronization accuracy, and improves the frame stability. The computing system 106 achieves enhanced mixed reality performance.

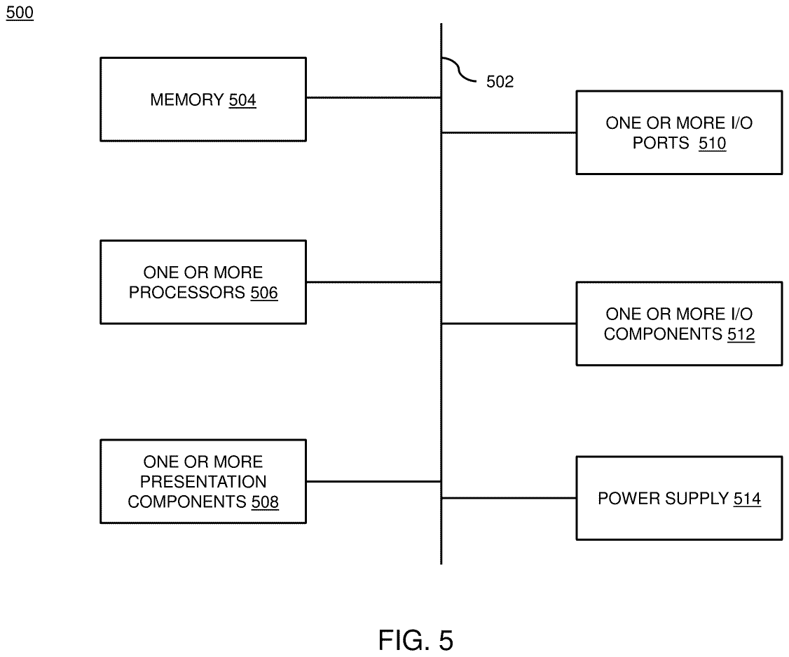

FIG. 5 illustrates a block diagram of an exemplary computing device 500 executing the rendering of the mixed reality content, in accordance with various embodiments of the present disclosure. The computing device 500 is a non-transitory computer-readable storage medium. The computing device 500 includes a bus 502 that directly or indirectly couples the following devices: memory 504, one or more processors 506, one or more presentation components 508, one or more input/output (I/O) ports 510, one or more input/output components 512, and an illustrative power supply 514. The bus 502 represents what may be one or more buses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 5 is merely illustrative of the exemplary device 500 that can be used in connection with one or more embodiments of the present disclosure. Distinction is not made between such categories as “workstation,” “server,” “laptop,” “hand-held device,” etc., as all are contemplated within the scope of FIG. 5 and reference to “device.”

In an embodiment of the present disclosure, the computing device 500 corresponds to a non-transitory computer-readable storage medium configured to store computer-executable instructions. The computer-executable instructions when executed by the one or more processors 506, cause the computing device 500 to generate, transform, and render the user-interaction-enabled mixed reality content. The stored instructions facilitate the hardware-level coordination among the one or more processors 506, the memory 504, the camera module 104a, and the display hardware. The hardware-tied execution enables the real-time transparent-overlay compositing, the spatial alignment of the one or more virtual elements, and the dynamic response to the user input. The hardware-tied execution results in efficient interaction-enabled mixed-reality rendering aligned to the hardware capabilities of the communication device 104.

The execution of the stored instructions improves the operation of the computing device 500 by reducing redundant processing cycles during the rendering, optimizing the scheduling across the CPU and the GPU pipelines, and enabling the dynamic adjustment of the interaction-dependent rendering parameters. The computing system 106 improves the data throughput efficiency, enhances the frame synchronization between the camera imagery and the one or more transparent video overlays, and reduces the visual latency during the user interactions. The technical improvements support the deployment of the lightweight, interaction-responsive mixed reality applications capable of stable real-time performance on devices with constrained computational resources.

In an embodiment of the present disclosure, the non-transitory computer-readable storage medium corresponds to a tangible computing element configured to store executable instructions. The instructions are executed by the one or more processors 506 to implement the hardware-assisted mixed reality interaction process. The stored instructions enable the processor, memory, and display hardware of the communication device 104 to cooperate in processing the user inputs, managing the overlay rendering, and maintaining the real-time spatial synchronization between the one or more virtual elements and the physical elements. The non-transitory nature of the storage medium ensures that the operations are executed through physical computing hardware. The hardware-tied execution produces verifiable technical improvements, such as reduced real-time rendering latency, improved data throughput efficiency, and enhanced visual consistency of interactive mixed reality content.

The computing device 500 typically includes a variety of computer-readable media. The computer-readable media can be any available media that can be accessed by the computing device 500 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 500 includes the one or more processors 506 that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device, etc.

The present disclosure is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A computing system for enabling interaction with mixed-reality (MR) content, the computing system comprising:
one or more processors; and
a non-transitory memory storing computer-executable instructions that, when executed, cause the one or more processors to:
detect, at a communication device, a triggering action from a plurality of triggering actions for accessing the mixed-reality content;
transform the mixed-reality content to obtain user-interaction-enabled mixed-reality content by superimposing one or more transparent video overlays comprising one or more virtual elements, wherein the one or more virtual elements are overlaid onto a real-time view of an environment captured by a camera module of the communication device;
render the transformed mixed-reality content on the communication device;
receive a user input through the communication device for interacting with the user-interaction-enabled mixed-reality content, wherein the interaction is performed through the one or more virtual elements;
analyze the received user input to determine an interaction intent associated with the rendered mixed-reality content;
dynamically optimize the mixed-reality content based on the determined interaction intent by executing one or more actions on the rendered mixed-reality content; and
render the optimized mixed-reality content on the communication device, wherein the mixed-reality content is updated and rendered continuously based on incremental user inputs to enable seamless interaction with the optimized mixed-reality content,
wherein the one or more processors and the non-transitory memory cooperate with the camera module, display hardware, and input sensors of the communication device to perform hardware-level adaptation of the rendering and data-processing operations for reducing real-time latency, improving user-interaction responsiveness, and maintaining spatial alignment accuracy between the one or more virtual elements and captured physical imagery.

2. The computing system of claim 1, wherein the instructions, when executed, cause the one or more processors to be operable to receive a user input, wherein the user input comprises one of a gesture-based input, a voice-based input, a touch-based input, or a text-based input for interacting with the one or more virtual elements rendered within the mixed reality content.

3. The computing system of claim 1, wherein the one or more transparent video overlays comprise an alpha channel video overlay configured to preserve background transparency of a real-time view of the physical environment captured by the camera module of the communication device.

4. The computing system of claim 3, wherein the alpha channel video overlay enables selective visibility of the one or more virtual elements and preserves a visibility of real-time imagery of the physical environment captured by the camera module.

5. The computing system of claim 1, wherein the one or more virtual elements are integrated onto a real-time view captured by the camera module of the communication device to enable spatially coherent mixed reality rendering.

6. The computing system of claim 1, wherein the instructions, when executed, cause the one or more processors to be operable to adjust the one or more transparent video overlays in real time based at least on data received from the camera module and user movement data, wherein the adjustment enables spatial alignment of the one or more virtual elements with the physical environment.

7. The computing system of claim 1, wherein the mixed reality content is rendered using an adaptive user interface framework configured to dynamically adjust a layout and an interaction model based at least on user interaction history, device type, and environmental conditions.

8. The computing system of claim 1, wherein the instructions, when executed, cause the one or more processors to be operable to dynamically optimize a user interaction experience with the one or more virtual elements by:
analyzing at least one of user interaction data, user movement data, and environmental data;
prioritizing at least one of a type of user interaction or a layout of the one or more virtual elements based on the analysis; and
rendering the mixed reality content with an optimized user interface based on the prioritization.

9. The computing system of claim 1, wherein the instructions, when executed, cause the one or more processors to be operable to anchor the one or more virtual elements persistently within the physical environment, wherein the anchoring comprises:
identifying one or more physical surfaces in the physical environment and contextually placing the one or more virtual elements relative to the one or more physical surfaces;
generating a visual preview of the one or more virtual elements overlaid in the physical environment;
dynamically adjusting a spatial position of the one or more virtual elements based on the user input;
tracking user movement using data from the camera module of the communication device; and
dynamically updating at least one of a positioning, orientation, or appearance of the one or more virtual elements in response to the user movement.

10. The computing system of claim 1, wherein the transformation and the rendering of the mixed reality content comprises:
activating a modular mixed reality engine in response to the detected triggering action, wherein the modular mixed reality engine comprises a plurality of mixed reality modules;
recognizing a usage context based on hardware capabilities of the communication device, environmental data, and metadata associated with the detected triggering action;
identifying at least one mixed reality module from the plurality of mixed reality modules based on the recognized usage context; and
dynamically loading and deploying the identified mixed reality module within a secure execution framework for rendering the mixed reality content with the interaction-enabled one or more virtual elements.

11. The computing system of claim 1, wherein the plurality of triggering actions corresponds to a mode for initiating a device-agnostic and platform-agnostic access to the mixed reality content, wherein the plurality of triggering actions comprise at least:
scanning a Quick Response (QR) code through the camera module of the communication device;
selecting a hyperlink received on the communication device; and
detecting a near-field communication (NFC) tag through the communication device.

12. A computer-implemented method executed by one or more processors of a computing system for enabling interaction with mixed-reality (MR) content, the computer-implemented method comprising:
detecting, at a communication device, a triggering action from a plurality of triggering actions for accessing the mixed-reality content;
transforming the mixed-reality content to obtain user-interaction-enabled mixed-reality content by superimposing one or more transparent video overlays comprising one or more virtual elements, wherein the one or more virtual elements are overlaid onto a real-time view of an environment captured by a camera module of the communication device;
rendering the transformed mixed-reality content on the communication device;
receiving a user input from a user through the communication device for interacting with the user-interaction-enabled mixed-reality content, wherein the interaction is performed through the one or more virtual elements;
analyzing the received user input to determine an interaction intent associated with the rendered mixed-reality content;
dynamically optimizing the mixed-reality content based on the determined interaction intent by executing one or more actions on the rendered mixed-reality content; and
rendering the optimized mixed-reality content on the communication device, wherein the mixed-reality content is updated and rendered continuously based on incremental user inputs to enable seamless interaction with the optimized mixed-reality content,
wherein the one or more processors execute the computer-executable instructions that improve operation of the communication device through hardware-level coordination among the one or more processors, a memory, the camera module, and display hardware to manage graphical and sensor workloads, wherein the one or more processors execute the hardware-level coordination to reduce computational overhead, enhance frame stability, and achieve spatial coherence between the one or more virtual elements and one or more physical elements in real time.

13. The computer-implemented method of claim 12, wherein the user input comprises one of a gesture-based input, a voice-based input, a touch-based input, or a text-based input for interacting with the one or more virtual elements rendered within the mixed reality content.

14. The computer-implemented method of claim 12, wherein the one or more transparent video overlays comprise an alpha channel video overlay configured to preserve background transparency of a real-time view of the physical environment captured by a camera module of the communication device.

15. The computer-implemented method of claim 14, wherein the alpha channel video overlay enables selective visibility of the one or more virtual elements and maintains visibility of a real-time imagery of the physical environment captured by the camera module.

16. The computer-implemented method of claim 12, wherein the one or more processors are further operable to execute an instruction for adjusting the one or more transparent video overlays in real time based at least on real-time data from the camera module and real-time user movement data, wherein the adjustment enables spatial alignment of the one or more virtual elements with the physical environment.

17. The computer-implemented method of claim 12, wherein the mixed reality content is rendered using an adaptive user interface framework that dynamically adjusts a layout and interaction model based at least on user interaction history, device type, and environmental conditions.

18. The computer-implemented method of claim 12, wherein the one or more processors are further operable to anchor the one or more virtual elements persistently within the physical environment, wherein the anchoring comprises:
identifying one or more physical surfaces in the physical environment and contextually placing the one or more virtual elements relative to the one or more physical surfaces;
tracking user movement using data from the camera module of the communication device; and
dynamically updating at least one of a positioning, orientation, or appearance of the one or more virtual elements in response to the user movement.

19. The computer-implemented method of claim 12, wherein the transformation and the rendering of the mixed reality content comprises:
activating, by the one or more processors, a modular mixed reality engine in response to the detected triggering action, wherein the modular mixed reality engine comprises a plurality of mixed reality modules;
recognizing, by the one or more processors, a usage context based on hardware capabilities of the communication device, environmental data, and metadata associated with the detected triggering action in real time; and
dynamically loading and deploying, by the one or more processors, at least one identified mixed reality module within a secure execution framework for the rendering of the mixed reality content with interaction-enabled virtual elements on the communication device.

20. A non-transitory computer-readable storage medium storing computer-executable instructions which, when executed by one or more processors of a computing device, cause the computing device to perform a method for enabling interaction with mixed-reality (MR) content, the method comprising:
detecting, at a communication device, a triggering action from a plurality of triggering actions for accessing the mixed-reality content;
transforming the mixed-reality content to obtain user-interaction-enabled mixed-reality content by rendering superimposing one or more transparent video overlays comprising one or more virtual elements, wherein the one or more virtual elements are overlaid onto a real-time view of an environment captured by a camera module of the communication device;
rendering the transformed mixed-reality content on the communication device;
receiving a user input through the communication device for interacting with the user-interaction-enabled mixed-reality content, wherein the interaction is performed through the one or more virtual elements;
analyzing the received user input to determine an interaction intent associated with the rendered mixed-reality content;
dynamically optimizing the mixed-reality content based on the determined interaction intent by executing one or more actions on the rendered mixed-reality content; and
rendering the optimized mixed-reality content on the communication device, wherein the mixed-reality content is updated and rendered continuously based on incremental user inputs to enable seamless interaction with the optimized mixed-reality content,
wherein execution of the stored instructions causes a hardware-level adaptation of data-processing and rendering operations across the one or more processors, memory, camera module, and display hardware of the communication device, resulting in improved throughput efficiency, reduced rendering latency, and perceptually stable mixed-reality interaction.
